(19) United States
(12) Patent Application Publication
(10) Pub. No.: US 2013/0075382 A1
(43) Pub. Date: Mar. 28, 2013

(54) DIELECTRIC BARRIER DISCHARGE WIND TUNNEL

(71) Applicant: Subrata Roy, Gainesville, FL (US)

(72) Inventor: Subrata Roy, Gainesville, FL (US)

(73) Assignee: UNIVERSITY OF FLORIDA RESEARCH FOUNDATION, INC., GAINESVILLE, FL (US)

(21) Appl. No.: 13/702,294

(22) PCT Filed: Jun. 7, 2011
(86) PCT No.: PCT/US11/39501

§ 371 Date: Dec. 5, 2012

Related U.S. Application Data
(60) Provisional application No. 61/352,190, filed on Jun. 7, 2010.

(51) Int. Cl. H05B 1/00

(52) U.S. Cl. CPC H05B 1/00
USPC 219/201

(57) ABSTRACT

Embodiments of the subject invention are directed to methods and apparatus for inducing fluid flow in a wind tunnel using one or more plasma actuators. In an embodiment, a wind tunnel is provided having a flow passage. A pair of electrodes is positioned on at least one surface of the flow passage, and a voltage potential is applied across the pair of electrodes producing a plasma discharge in the flow passage. In an embodiment, the pair of electrodes is positioned on the at least one surface of the flow passage such that when the plasma discharge is produced an electrohydrodynamic (EHD) body force is generated that induces flow of a fluid in the flow passage.

The subject invention was made with government support under Air Force Office of Scientific Research, Contract No. FA9550-09-1-0416. The government has certain rights to this invention.

### BACKGROUND OF INVENTION

Challenges in traditional wind tunnels include disturbances that affect the flow characterization at all speed regimes. This is especially problematic at low and moderate speeds where vibration from a blower or fan at off-design points can introduce unsteadiness in the fluid flow. While there are arc discharge plasma wind tunnels for high speed applications, such wind tunnels are not suitable for low speed flow characterization or testing of small structures.

### BRIEF SUMMARY

Embodiments of the subject invention are directed to a method and apparatus for inducing fluid flow in a wind tunnel using one or more plasma actuators. In an embodiment, a wind tunnel is provided having a flow passage. A pair of electrodes is positioned on at least one surface of the flow passage, and a voltage potential is applied across the pair of electrodes producing a plasma discharge in the flow passage. The pair of electrodes can be positioned such that when the plasma discharge is produced an electrohydrodynamic (EHD) body force is generated that induces flow of a fluid in the flow passage.

In an embodiment, a testing chamber is positioned in the flow passage and the EHD body force generated tends to induce flow of the fluid toward the testing chamber. In an embodiment, a subject to be tested is positioned in the flow passage and the EHD body force generated tends to induce flow of the fluid toward the subject. In an embodiment, the pair of electrodes is positioned such that the EHD body force generated tends to reduce a shear force on a surface of the flow passage. In another embodiment, the pair of electrodes is positioned at or near a corner of the flow passage such that EHD body force generated tends to redirect flow around the corner. The EHD body force generated can result in a smoother flow, decreased pressure loss, and/or reduced boundary layer separation. In a further embodiment, the pair of electrodes is positioned such that the EHD body force generated tends to contract or defuse flow of the fluid. In yet another embodiment, the pair of electrodes is positioned at or near an inlet of the flow passage and the EHD body force generated tends to direct flow of the fluid into the inlet. In yet another embodiment, the pair of electrodes is positioned at or near an outlet of the flow passage and the EHD body force generated tends to direct flow of the fluid out of the outlet. The EHD body force generated can tend to induce laminar flow in the fluid. In another embodiment, the EHD body force generated tends to induce turbulent flow in the fluid. In other embodiments, the EHD body force generated is used to otherwise control the flow of the fluid in the flow passage.

Various configurations of electrodes can be used with various embodiments of the subject invention. A pair of electrodes can be positioned on one of the at least one surface of the flow passage. In an embodiment, the surface incorporates an insulating material, an exposed electrode of the pair of electrodes is exposed to an inside of the flow passage, and an embedded electrode of the pair of electrodes is separated from the exposed electrode by the insulating material such that when the pair of electrodes is powered a surface discharge is produced. In another embodiment, a pair of electrodes is positioned across at least a portion of the flow passage such that when the pair of electrodes is powered a volumetric discharge is produced. Additional pairs of electrodes can be positioned in the flow passage and powered to produce additional plasma discharges. In an embodiment, three or more electrodes are positioned in the flow passage and powered in phased pairs. In yet another embodiment, one or more multi-barrier plasma actuators are utilized. The embodiments presented here are illustrative examples. Various other configurations can be used with the subject invention.

### BRIEF DESCRIPTION OF DRAWINGS

FIG. 1 shows a diagram of a wind tunnel in accordance with an embodiment of the subject invention.

FIG. 2 shows fluid flow inside a channel in accordance with an embodiment of the subject invention.

FIG. 3 is a schematic diagram for flow actuation using surface dielectric barrier discharge (DBD) in accordance with an embodiment of the subject invention.

FIG. 4 is a diagram showing force variation of electric body force qE about the electrode-dielectric surface in accordance with an embodiment of the subject invention.

FIG. 5 is a diagram showing predicted streamwise gas velocity profiles induced by a body force, shown along different locations along the flow under a quiescent gas environment, in accordance with an embodiment of the subject invention.

FIG. 6 is a schematic diagram of one embodiment of a multilayer actuator in accordance with the subject invention.

FIG. 7 is a schematic diagram of a second embodiment of a multilayer actuator of the present disclosure, with an increased number of layers.

FIG. 8 is a schematic diagram showing flow actuation used for creating large or small counter rotating vortices in accordance with an embodiment of the subject invention.

FIG. 9 illustrates several additional exemplary embodiments of the multilayer actuators of the present disclosure.

FIGS. 10A and 10B show specific embodiments of the invention having certain relationships between driving voltage and amplitudes and frequencies.

FIGS. 11A and 11B show specific embodiments of the invention for creating a flow force directed away from the substrate.

FIGS. 12A and 12B show specific embodiments of the invention for creating a flow force directed toward the substrate.

FIG. 13 shows a specific embodiment having a serpentine turbulator design for creating a flow force directed away from the substrate.

FIG. 14 shows a specific embodiment having a serpentine turbulator design for creating a flow force directed toward the substrate.

FIG. 15 shows various specific embodiments of the subject invention.

FIGS. 16A and 16B show an embodiment having a horseshoe shaped electrode pattern.

FIG. 17 shows a flow pattern for the embodiment of FIG. 16A.

FIGS. 18A-18C show data illustrating the operation of the embodiment of FIG. 16A.

FIG. 19 shows a schematic diagram of a flow passage configured to use a DBD in accordance with an embodiment of the subject invention.

FIG. 20 shows a schematic diagram of a flow passage using a volumetric plasma discharge in accordance with an embodiment of the subject invention.

FIG. 21 shows a schematic diagram of a flow passage configured to use volumetric plasma discharges in accordance with another embodiment of the subject invention.

FIG. 22 shows a schematic diagram of a flow passage configured to use volumetric plasma discharges in accordance with yet another embodiment of the subject invention.

FIG. 23 shows various flow passage configurations in accordance with embodiments of the subject invention.

FIG. 24 shows various flow passage cross-sections in accordance with embodiments of the subject invention.

FIG. 25 shows a schematic of a flow passage design according to an embodiment of the subject invention.

FIGS. 26A-26C illustrate different arrangements of electrodes in a flow passage according to embodiments of the subject invention.

FIGS. 27A and 27B illustrate different positioning of electrodes along the inner perimeter P of a flow passage for creating straight and swirl pumping effects, according to embodiments of the subject invention, where the inner surface of the flow passage has been laid out flat for illustration purposes.

FIGS. 28A and 28B show embodiments incorporating parallel plate flow passages.

FIG. 29 shows Knudsen number regimes for modeling fluid flow through a flow passage in accordance with embodiments of the subject invention.

FIG. 30 shows pressure change as a function of position in a wind tunnel according to an embodiment of the subject invention.

FIG. 31 shows pressure change as a function of position in a wind tunnel according to an embodiment of the subject invention.

### DETAILED DISCLOSURE

Embodiments of the subject invention are directed to a method and apparatus for inducing fluid flow in a wind tunnel using one or more plasma actuators. In an embodiment, a wind tunnel is provided that uses one or more plasma actuators to induce fluid flow in a flow passage. In an embodiment, less mechanical vibration is created than in a traditional wind tunnel employing a blower or fan. In a further embodiment, plasma actuators are used to augment the fluid flow induced by a blower or fan. In a specific embodiment, a wind tunnel is produced having no rotating or mechanical components, such as a solid state wind tunnel.

In an embodiment, a plasma actuator of the one or more plasma actuators incorporates at least one pair of electrodes positioned on one or more surfaces of the flow passage. When a voltage potential is applied across one of the at least one pair of electrodes a plasma discharge is produced that induces fluid flow in the flow passage. In an embodiment, when the plasma discharge is produced an electrohydrodynamic (EHD) body force is generated which induces fluid flow in the flow passage. In a further embodiment, a plurality of such actuators is used. A voltage potential can be applied to each actuator in timed phases. For example, three or more electrodes can be positioned in the flow passage and powered in phased pairs.

In an embodiment of the subject invention, a pair of electrodes is positioned on one of the at least one surface of the flow passage. In an embodiment, the surface incorporates an insulating material, an exposed electrode of the pair of electrodes is exposed to an inside of the flow passage, and an embedded electrode of the pair of electrodes is separated from the exposed electrode by the insulating material such that when the pair of electrodes is powered a surface discharge is produced. In another embodiment, a pair of electrodes is positioned across at least a portion of the flow passage such that when the pair of electrodes is powered a volumetric discharge is produced. A multi-layer arrangement of electrodes can be used in which electrodes are arranged in a plurality of layers, each layer of electrodes separated by an insulating material. In an embodiment, several layers of a dielectric substrate are formed, each layer enveloping at least one electrode.

At least one power source can be provided for powering the electrodes. In an embodiment, the pair of electrodes includes a grounded electrode and a powered electrode, which is powered to achieve the voltage potential. In an alternative embodiment, both electrodes of the pair are powered at different voltages to achieve the voltage potential. In various embodiments, alternating current (AC) and/or direct current (DC) power sources can be used. In an embodiment, electrodes pairs on the same surface or layer are maintained at a potential bias using steady, pulsed direct, or alternating current. Electrode pairs can be separated by an insulating material where one electrode of the pair is powered with dc or ac operating at a radio frequency (RF) with respect to the other. In an embodiment, a powered electrode of the pair is powered at RF voltages, while a grounded electrode of the pair is grounded. In an alternative embodiment, both electrodes are powered with signals separated by a beat frequency.

In an embodiment of the subject invention, pairs of electrodes or actuators are powered in parallel (i.e., at the same time) to generate multiple plasma discharges within the flow passage at the same time. In another embodiment, pairs of electrodes or actuators are powered in series to generate sequential plasma discharges within the flow passage. In yet another embodiment, pairs of electrodes or actuators are powered in both parallel and sequential groupings. A particular electrode, among the plurality, can be paired with a first electrode, among the plurality, to generate a first plasma discharge. Later, the particular electrode can be paired with a second electrode, among the plurality, to generate a second plasma discharge.

An illustrative embodiment incorporates a power source; a first electrode in contact with a first dielectric layer and connected to the power source; a second electrode in contact with a second dielectric layer and connected to the power source; and a ground electrode. The power source drives the first electrode with a first ac voltage pattern with respect to the ground electrode and drives the second electrode with a second ac voltage pattern with respect to the ground electrode such that application of the first voltage pattern produces a first plasma discharge in a flow passage, and a first electric field pattern in the flow passage, and application of the second voltage pattern produces a second plasma discharge in the flow passage and a second electric field pattern in the flow passage. The first and second electrodes are offset along the direction of flow in the flow passage and the first voltage pattern and the second voltage pattern have a phase difference such that the first and second electric fields drive flow in the flow passage in different portions of the flow passage at different times.

In an embodiment of the subject invention, the fluid flow induced in the flow passage can be varied by controlling the applied voltage potential, phase angle, and/or frequency across each one of these actuators. In an embodiment, fluid flow is induced toward a test subject positioned in the flow passage. In another embodiment, a test chamber is positioned in the flow passage and fluid flow is induced toward the test chamber. Various measuring devices, such as pressure taps, pressure transducers, anemometers, hot-wire anemometers, acoustic flow meters, and/or laser velocimeters can be positioned on or near the test chamber and/or the test subject to take useful measurements. In an embodiment, a test subject is positioned in the test chamber while the fluid flow is applied to the test subject. The pair of electrodes can be positioned such that the EHD body force generated tends to reduce a shear force on a surface of the flow passage. In another embodiment, the pair of electrodes is positioned at or near a corner of the flow passage such that EHD body force generated tends to redirect flow around the corner. The EHD body force generated can result in a smoother flow, decreased pressure loss, and/or reduced boundary layer separation. In yet another embodiment, the pair of electrodes is positioned such that the EHD body force generated tends to contract or defuse flow of the fluid. The pair of electrodes can be positioned at or near an inlet of the flow passage and the EHD body force generated tends to direct flow of the fluid into the inlet. Likewise, the pair of electrodes can be positioned at or near an outlet of the flow passage and the EHD body force generated tends to direct flow of the fluid out of the outlet. In an embodiment, the EHD body force generated tends to induce laminar flow in the fluid. In another embodiment, the EHD body force generated tends to induce turbulent flow in the fluid. The EHD body force generated can be used to otherwise control the flow of the fluid in the flow passage.

Depending on the type of dielectric barrier discharge actuators used (for example, single dielectric barrier discharge actuator, multi-barrier plasma actuator, or 3D serpentine type actuator), a turbulent flow can be reached quickly with minimal entry length and/or stay in laminar regime or transition to turbulence. Such a wind tunnel can be useful for testing micron scale structures. For example, such a wind tunnel can be used to test subjects having dimensions less than about one millimeter. In a further embodiment, such a wind tunnel can be used to test subjects having dimensions less than about 100 microns. In another embodiment, such a wind tunnel can be used to test subjects having dimensions less than about 10 microns. In an embodiment, the wind tunnel is used to characterize low speed fluid flow. For example, such a wind tunnel can be used to produce freestream velocities less than about 100 meters per second. In a further embodiment, such a wind tunnel can be used to produce freestream velocities less than about 40 meters per second. In another embodiment, the wind tunnel is used to characterize small structures at laminar to turbulent flow regime. For example, in an embodiment, the wind tunnel accommodates a test section that is less than about 0.5 square meters in area. In an alternative embodiment, the wind tunnel is used to study fluid flow at macro scales for energy and/or aerospace applications.

Various fluids can be used in such a wind tunnel. For example, a mixture can be used such as air. In an embodiment, a gas is used such as nitrogen. In another embodiment, a liquid is used such as mineral oil. Particulates, such as smoke, water vapor, or other particulates, can be included in the fluid. In an embodiment, such particulates are used to visualize the flow of a fluid within the wind tunnel as known in the art.

In an embodiment of the subject invention, the wind tunnel has at least two sections: a flow generation section and a test chamber. In an embodiment, the flow generation section and the test chamber are separated by a screen to reduce large scale flow structures in the flow, if any, introduced by the plasma actuators.

The figures of the subject invention are not necessarily to scale and the relative distances between electrodes and electrode pairs can vary from those shown.

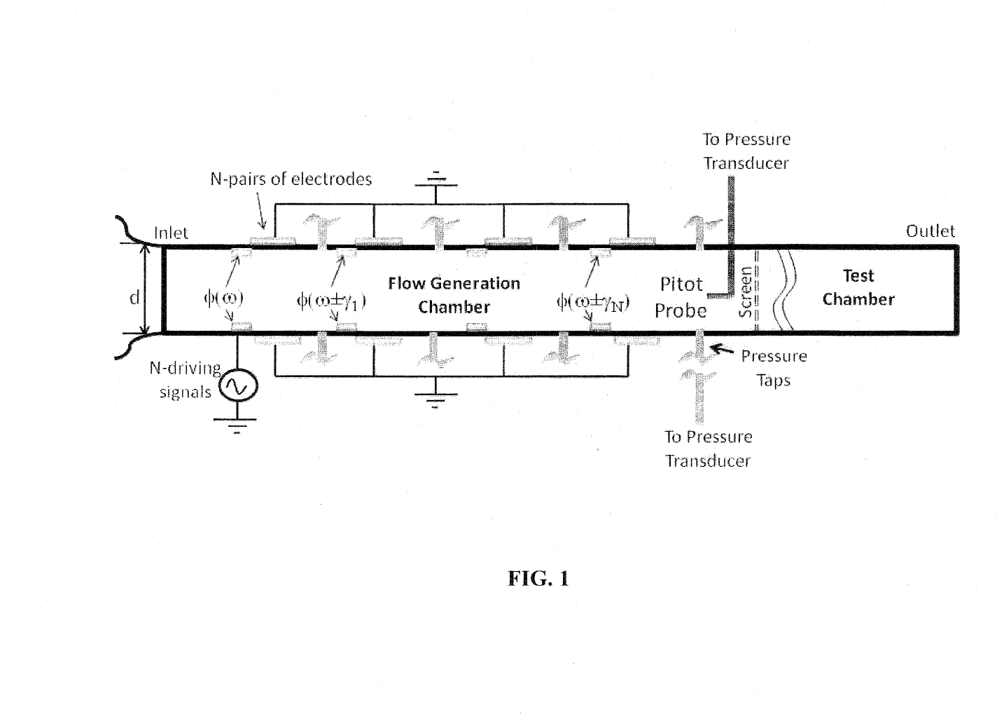

FIG. 1 shows a diagram of a wind tunnel in accordance with an embodiment of the subject invention. In the embodiment shown, N pairs of electrodes are arranged along a flow passage having height d. A first electrode of each pair is powered using a driving signal and a second electrode of each pair is grounded. In an alternative embodiment, both electrodes of each pair can be powered by signals separated by a beat frequency. In the embodiment shown, the first electrode of each pair is exposed to the flow passage and the second electrode of each pair is separated from the flow passage and the first electrode by a surface of the wind tunnel. In a particular embodiment, the surface of the wind tunnel includes an insulating material. In an alternative embodiment, both electrodes of a pair can be exposed to the flow passage. In a further embodiment, the pair of electrodes can be separated by a portion of the flow passage. When the electrodes are powered a plurality of plasma discharges (not shown) are created in the flow passage inducing flow of a fluid present in the flow passage. The plurality of plasma discharges can be produced in parallel, in series, or both. In the embodiment shown, flow is induced toward a test chamber positioned in the flow passage. The plasma discharges can be surface discharges, volumetric discharges, or both. In an embodiment, at least one of the plasma discharges generates an EHD body force that induces flow of the fluid.

Various other structures can be used to affect the flow of the fluid in the flow passage. In the embodiment shown, a screen is positioned between a flow generation portion of the flow passage (having the N pairs of electrodes positioned therein) and the test chamber. The screen can reduce the presence of large scale structures in the flow of the fluid before the fluid reaches the test chamber. In other embodiments, additional screens, honeycombs, vanes, or other structures are used to affect the flow of fluid in the flow passage as is known in the art. In other embodiments, the shape of the flow passage itself can be used to affect the flow of the fluid in various parts of the flow passage as is known in the art. For example, the passage can be narrowed to contract flow or widened to diffuse flow.

In embodiments of the subject invention, various sensors can be used to measure properties of the flow in the flow passage. In the embodiment shown in FIG. 1, pressure taps are positioned along the flow passage for measuring pressure at different regions of the flow passage. In the embodiment shown, pressure transducers are also used to measure differences in pressure in the flow passage. In a particular embodiment, such pressure differences are used to calculate flow velocities in the flow passage. In other embodiments, other sensors can be used to measure velocities, such as anemometers, hot-wire anemometers, acoustic flow meters, laser velocimeters, among other devices. Various other sensors can also be incorporated for various other purposes.

In the embodiment shown in FIG. 1, the test chamber is positioned at the outlet of the flow passage. In other embodiments, the test chamber can be positioned closer to the inlet of the flow passage, in the center of the flow passage, or another location. In the embodiment shown, the flow passage is arranged in an open circuit having at least one inlet and at least one outlet. In other embodiments, the flow passage can be arranged in a closed circuit as discussed above. In a further embodiment, additional actuators are arranged at or near an inlet of the flow passage to draw fluid into the passage. In another embodiment, additional actuators are arranged at or near an outlet of the flow passage to draw fluid out of the passage. In yet another embodiment, additional actuators are arranged at or near a corner of the flow passage to redirect flow of the fluid around the corner. In other embodiments, actuators can be positioned in other configurations to otherwise shape the flow of the fluid passing through the passage. For example, such actuators can be used to direct flow toward or away from a surface of the flow passage, to contract flow, to diffuse flow, to create laminar flow, to create turbulent flow, among other possibilities.

In an embodiment of the subject invention, an EHD body force is used to control the flow of a fluid through a channel, flow passage, or other flow region. In an embodiment, a plurality of electrodes are arranged and powered to create a plasma discharge, which can impart an EHD body force to the fluid. Various configurations of electrodes can be used to control the flow of the fluid into, out of, or through the flow region. In an embodiment, a surface discharge can be produced by arranging and powering electrodes on one surface of a flow region. In another embodiment, a volumetric discharge can be produced by arranging and powering electrodes across the flow region.

In an embodiment of the subject invention, a micro channel can be formed with electrodes arranged therein. A small plasma discharge can be generated in the vicinity of an exposed (powered) electrode to induce an EHD body force, which can induce flow of a fluid in a particular direction. The electrodes can be arranged in the micro channel as electrode pairs. One embodiment can incorporate electrode pairs on the same surface and maintained at a potential bias using steady, pulsed direct, or alternating current. Another embodiment can incorporate electrode pairs separated by an insulating material where one electrode of the pair is powered with dc or ac operating at a radio frequency with respect to the other. In an embodiment, one electrode of the pair is powered at RF voltages, while the other electrode of the pair is grounded. In another arrangement, both electrodes are powered with signals separated by a beat frequency. In another embodiment, electrodes are arranged and powered such that the EHD body force produced induces flow of the fluid into or out of the micro channel. In yet another embodiment, the use of EHD body forces can reduce, or substantially eliminate, shear forces on the surface of the micro channel.

Wind tunnels in accordance with the invention can be used to induce flow in a variety of fluids. Flow can be induced in electrically non-conductive fluids and electrically conductive fluids. In an embodiment, some electrodes can be fully or partially submerged or embed in an insulating material, such as a dielectric. In an embodiment, some electrodes can be coated with a material having insulating properties, such as a dielectric material. In an embodiment, some electrodes can be exposed to the fluid.

In an embodiment of the subject invention, voltages are applied to different electrodes at different times in order to control the flow of fluid through the flow passage. In an embodiment, a controller is provided that controls the timing of voltage application to the electrodes. In an embodiment, the controller is controlled according to a computer program stored on one or more computer-readable media.

The wind tunnel can have various configurations. In an embodiment, the wind tunnel incorporates one or more channels. Such channels can have various cross-sections as further described below. In a further embodiment, a channel is formed having internal structures formed therein to further control flow through the channel. In another embodiment, channels are formed having a uniform cross-section along their length. In yet another embodiment, such channels can narrow or expand at one or both ends. In an embodiment, protrusions can be formed at the entrance, exit, or within such channels to further direct the flow of a fluid into, out of, a through the channel.

In an embodiment, plasma discharges are combined with other known techniques for inducing flow of a fluid through a wind tunnel. For example, a blower or fan can be used to induce flow of the fluid. Portions of the flow passage can be heated such that the enthalpy of the fluid increases through conduction, convection, or radiation of such heat to the fluid. In an embodiment, the enthalpy of the fluid is increased using plasma discharge. In another embodiment, electrostatic, magnetic, or electromagnetic forces are used to increase the flow of a charged fluid through a flow passage. Other techniques for increasing flow of a fluid through wind tunnel are known in the art and can be used with the subject invention.

In an embodiment, electrodes are arranged to produce a discharge at an entrance of a channel to draw fluid into the channel. For example, by arranging electrodes on either side of an entrance to a channel counter-rotating vortices can be produced that draw fluid into the channel. The same or different principles can be applied at an exit to the channel to draw fluid out of the channel.

In an embodiment, a plurality of electrodes is arranged and selectively powered to induce fluid flow through a channel, flow passage, or other flow region. In an embodiment, a pair of electrodes, among the plurality, is arranged along a surface of the flow region. Power can be applied to one or both electrodes to produce a surface dielectric barrier discharge (DBD). The DBD can in turn produce an EHD body force that induces flow in the fluid. In an embodiment, the EHD body force is produced by powering an exposed electrode at RF voltages, while an embedded electrode is grounded. In another arrangement, both electrodes are powered with signals separated by a beat frequency.

In an embodiment, a pair of electrodes, among the plurality, is positioned across a portion of the flow region from each other, such that the flow region is intersected by a straight line drawn between a point on one of the pair of electrodes and a point one the other of the pair of electrodes. Power can be applied to one or both electrodes to produce a volumetric plasma discharge. The discharge can produce an EHD body force that induces flow in the fluid. In an embodiment, the pair of electrodes is arranged on different surfaces forming the flow region. In an embodiment, the pair of electrodes is arranged on a curved or angled surface, such as a cylindrical surface. In an embodiment, one electrode of the pair is powered, while the other electrode of the pair is grounded. In another arrangement, both electrodes are powered at different voltages.

In an embodiment, pairs of electrodes, among the plurality, are powered in parallel (i.e., at the same time) to generate multiple plasma discharges within the flow region at the same time. In an embodiment, pairs of electrodes, among the plurality, are powered in series to generate sequential plasma discharges within the flow region. In an embodiment, a particular electrode, among the plurality, can be paired with a first electrode, among the plurality, to generate a first plasma discharge. Later, the particular electrode can be paired with a second electrode, among the plurality, to generate a second plasma discharge. Various configurations of electrodes can be used with the subject invention. Illustrative examples are provided below.

A specific embodiment can incorporate a power source; a first electrode in contact with a first dielectric layer and connected to the power source; a second electrode in contact with a second dielectric layer and connected to the power source; and a ground electrode. The power source drives the first electrode with a first ac voltage pattern with respect to the ground electrode and drives the second electrode with a second ac voltage pattern with respect to the ground electrode such that application of the first voltage pattern produces a first plasma discharge in a flow region, and a first electric field pattern in the flow region, and application of the second voltage pattern produces a second plasma discharge in the flow region and a second electric field pattern in the flow region. The first and second electrodes are offset along the direction of flow in the flow region and the first voltage pattern and the second voltage pattern have a phase difference such that the first and second electric fields drive flow in the flow region in different portions of the flow region at different times.

In an embodiment, the first dielectric and the second dielectric layer are arranged in a stacked configuration, such that the first dielectric layer contacts the second dielectric layer. The first electrode can be positioned near the flow region. The first dielectric can be positioned between the flow region and the second electrode such that both electrodes are positioned in the same direction from the flow region. Alternatively, the flow region, or at least a portion of the flow region can be positioned between the first and second electrodes. The first dielectric insulator layer and the second dielectric insulator layer have different dielectric strengths or can have the same dielectric strengths. The first electrode is offset from the second electrode in a direction parallel to a direction of flow in the flow region and one or more additional electrodes can be offset from the first and second electrodes and provide corresponding one or more additional electric fields to promote flow in the flow region.

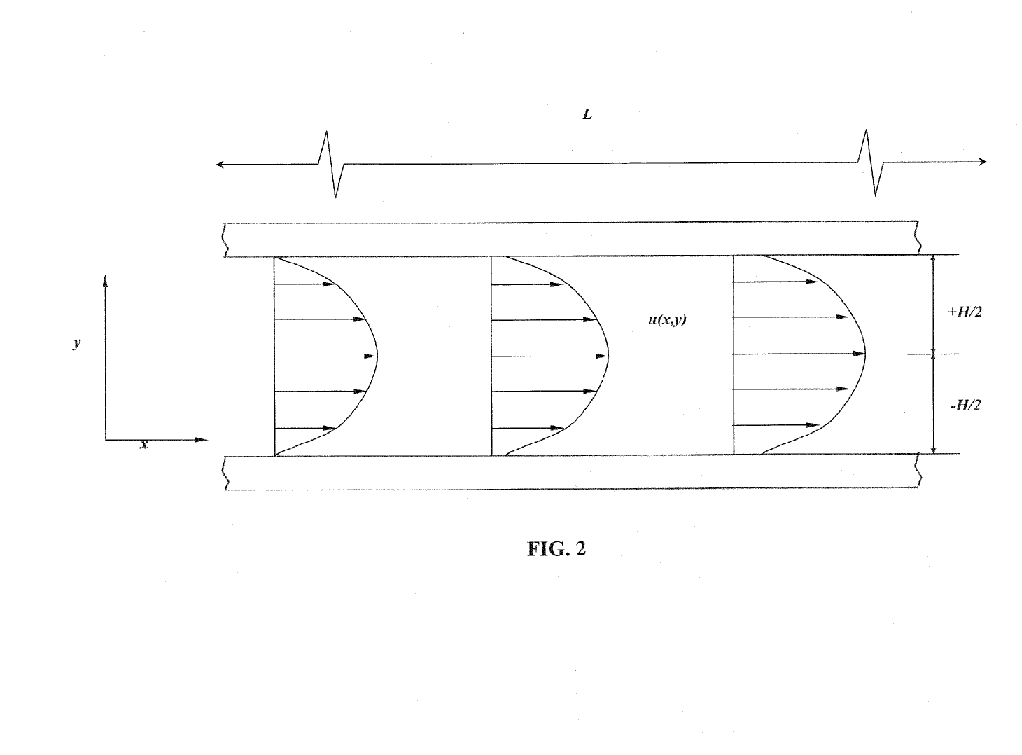

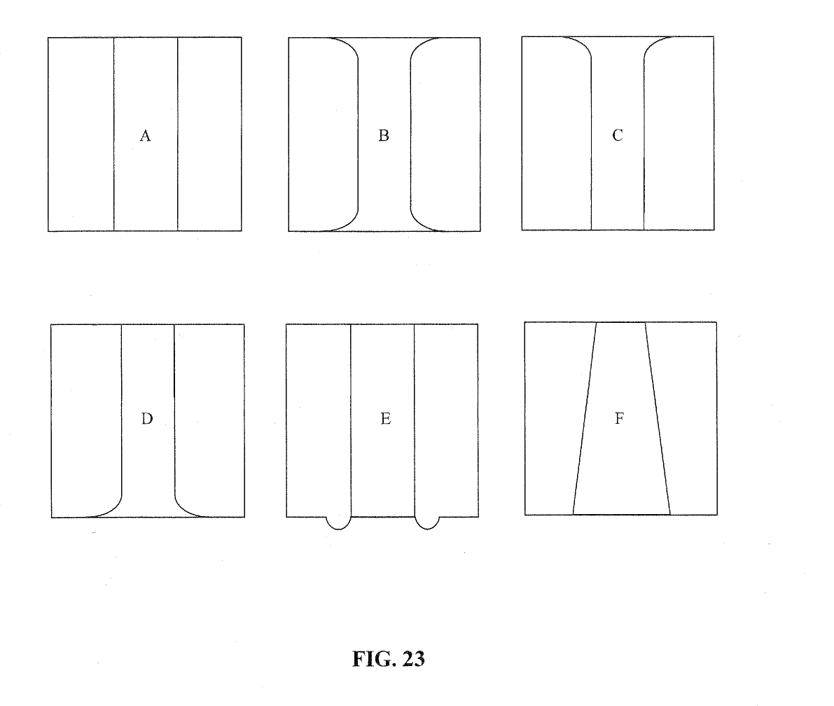

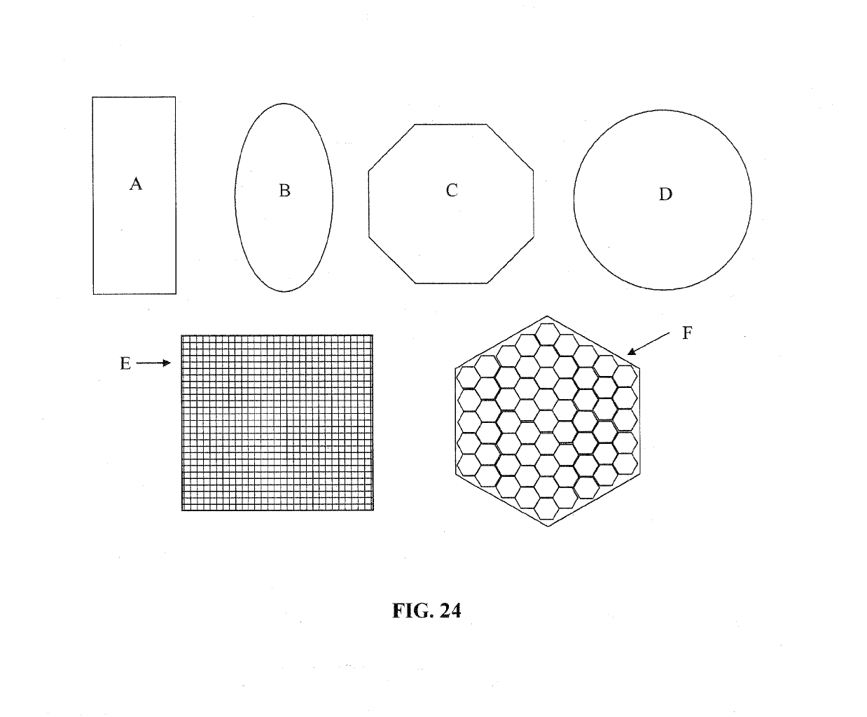

FIG. 2 shows fluid flow inside a channel in accordance with an embodiment of the subject invention. As shown, the channel has a channel height H and a length L. In an embodiment, the channel also has width W in a dimension perpendicular to the x and y axis shown. As discussed below in relation to FIGS. 23 and 24, the channel can have various configurations and cross-sections. In an embodiment, the channel is composed of two parallel plates of length L and width W separated by a distance H. In the embodiment shown, the length L is in the same dimension as the intended streamwise flow of fluid through the channel.

Channels useable with the subject invention may vary in size and dimension. In an embodiment, the channel width W is equal to the channel height H. In another embodiment, the channel width W is considerably larger than the channel height H. In a specific embodiment, the channel width W is about 30 to 40 times greater than the channel height H. In another embodiment, the channel width W is less than about 30 times greater than the channel height H. In yet another embodiment, the channel width W is more than about 40 times greater than the channel height H. In yet another embodiment, the channel width W is less than the channel height H. The length L of the channel can also vary. In an embodiment, the length L of the channel is considerably greater than its width W. In a specific embodiment, the channel length L is about 75 to 150 times greater than the channel width W. In another embodiment, the channel length L is more than about 150 times greater than the channel width W. In yet another embodiment, the channel length L is less than about 75 times greater than the channel width W. In yet another embodiment, the channel length L is less than the channel width W.

In an embodiment, the channel is a micro channel. In embodiments, the channel height H of the micro channel ranges from about 1 to 2 μm. In other embodiments, the channel height H of the micro channel ranges from about 100 to 300 nm. In other embodiments, the channel height H is less than about 100 nm. In other embodiments, the channel height H is more than about 2 μm. In a particular embodiment, the micro channel has height, width, and length of about 1.2, 40, and 4000 μm respectively. In a particular embodiment, the micro channel has height, width, and length of about 1.33, 52.25, and 7500 μm respectively.

In an embodiment, a plurality of electrodes are arranged along the length of the channel and powered to induce flow of a fluid through the channel. In an embodiment, electrodes are arranged at or near the entrance of the channel to draw fluid into the channel. In an embodiment, electrodes are arranged at or near the exit of the channel to draw fluid out of the channel. Various configurations of electrodes can be used with the subject invention. Illustrative examples are further discussed below.

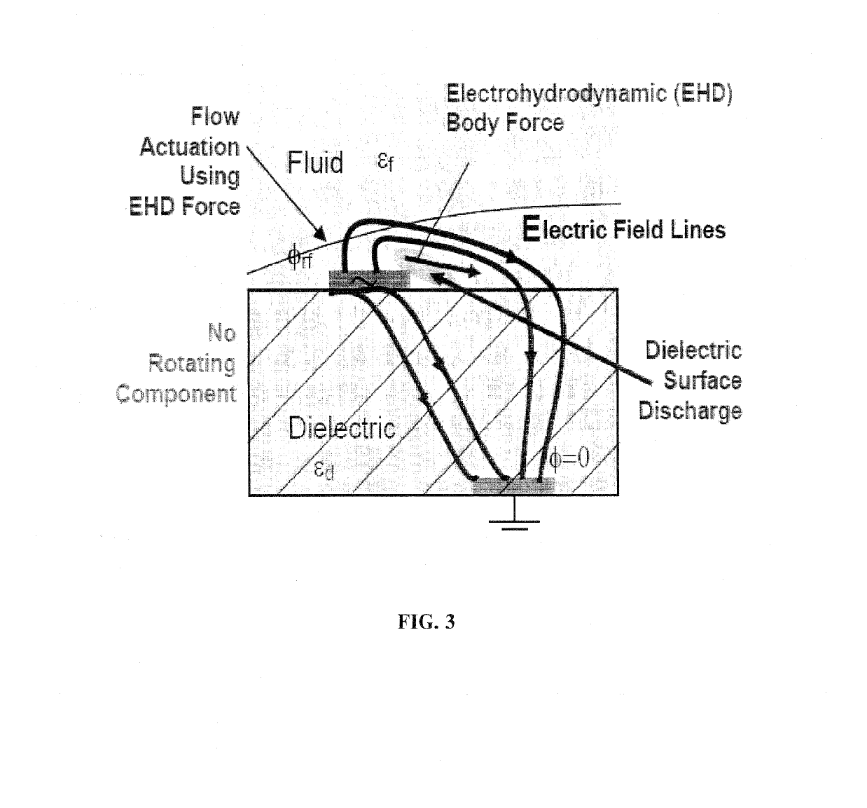

FIGS. 3-5 illustrate the process through which an electrodynamic qE body force actively controls the flow through an inducement of a wall jet in a quiescent condition. FIG. 3 shows the schematic for flow actuation using surface dielectric barrier discharge (DBD). Two electrodes are employed: the first exposed to the flow and the second embedded in the dielectric and displaced in the streamwise direction relative to the exposed electrode. The surface discharge so created contrasts with the volumetric effect observed when the electrodes are separated by the fluid. Typically, the actuator is excited by powering the exposed electrode at RF voltages, while the embedded electrode is grounded. In another arrangement, both electrodes are powered with signals separated by a beat frequency. The excitation induces a complex unsteady interaction between the two electrodes and the fluid, details of which depend on frequency, voltage, geometric configuration, and dielectric constants of the media.

In the surface discharge, within a very short time after breakdown, the discharge buildup at the dielectric surface sets off microdischarges of nanosecond duration, limiting the electric field at the location of the microdischarge such that the charge current at this position is cut off. Experimental evidence shows that there is no runaway state for the parameters under consideration and that an asymptotic (quasi) periodic state is reached, with a dominant frequency that is locked to the input perturbation. For a given interelectrode distance, as the applied voltage becomes sufficiently large, the dielectric surface adjacent to the RF electrode produces a barrier discharge, which weakly ionizes the surrounding gas. The combination of electrodynamic body force and collisional processes, whose detailed mechanics remain a matter of current research, ultimately transfers momentum acquired from the electric field by the charged particles to the neutrals which are the primary species.

Advantages of dielectric barrier-based discharges include, for example, an absence of moving parts, rapid on-off features, and the ability to apply body forces in a relatively precise manner by deploying advanced electromagnetic technology. Embodiments of the subject invention are thus suitable for flow control in micro channels, for example.

The electric field E exerts a net force qE through the space charge (q) separated plasma within the DBD. This microfilamentary discharge sustains an optical glow within a half cycle through many current pulses of nanosecond duration. The plasma can induce air flow up to several meters per second in atmospheric pressure. The parameters controlling such force include the applied voltage, frequency, dielectric characteristics, and the asymmetric configuration of the electrodes. The asymmetry in the location of the electrodes, coupled with the phase shift of the electrode when multiple devices are present, yields a directional asymptotic “push” on the bulk gas. The thickness of the exposed electrode affects the thrust produced by the actuator.

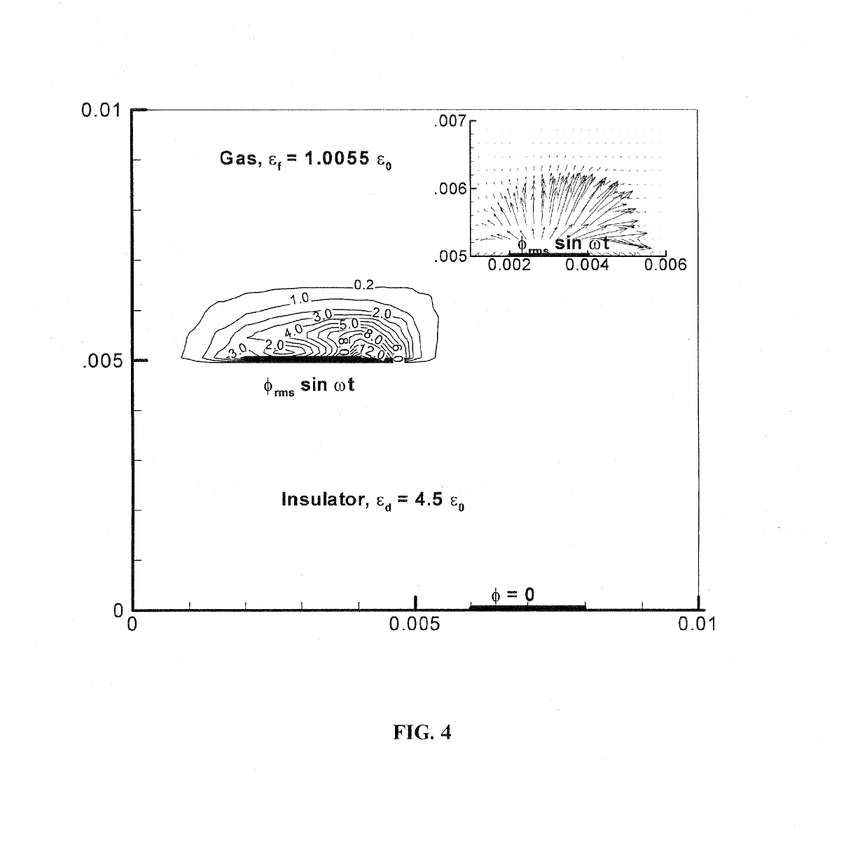

The variation of electric body force qE about the electrode-dielectric surface in FIG. 4 is predicted by using a multispecies formulation anchored in a high-fidelity finite element based multiscale ionized gas (MIG) flow code. The MIG code employs a self-consistent approach to model the near-wall physics of plasma gas interactions. The method is based on a versatile finite-element (FE) procedure adapted from fluid dynamics to overcome the stiffness of the equations generated by multi-species charge separation phenomena. A 2D bilinear finite element formulation is chosen with 4^{th} order Runge-Kutta time marching. The solution process includes at least two steps. The first solves the equations for charge and electric field simultaneously. In the second step, the force so obtained is transferred to the airfoil after rotation and scaling. The MIG code also solves for the self-consistent fluid response. This implicitly assumes that the near-wall local fluid neutral velocity does not influence the distribution of electric parameters. This requires that the fluid density and pressure, or collisionality, are not much different from those employed in the plasma calculation.

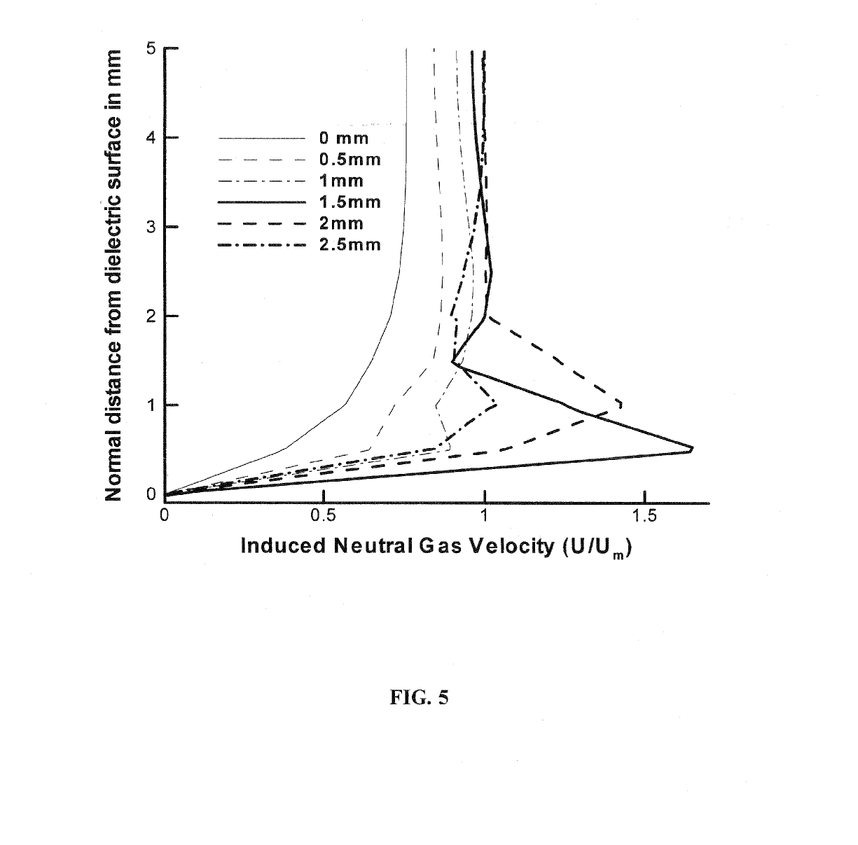

The result computed for helium working gas describes a localized peak of the body force in the vicinity of the exposed electrode powered with a RF voltage of 1 kV rms at 5 kHz. The predicted streamwise gas velocity profiles induced by this force are shown along different locations in FIG. 5 under a quiescent gas environment. For atmospheric air, the induced peak velocity of the wall jet is about 1-2 m/s, which may be further accentuated by using a polyphase power supply. While this creates striking flow control effects at low speeds, the induced momentum may be too small for sufficiently actuating the high speed flows.

A first principle electrohydrodynamic (EHD) formulation can be used for modeling plasma discharge induced flows. Reported experiments and theoretical predictions have been traditionally limited to low speeds and low power due to the problems of arcing and low conversion of electrical energy into gas momentum. Thus, the embodiments of the subject invention are directed to multibarrier actuators using several layers of dielectric barriers with embedded electrodes for moderate to high speed applications. Embodiments of the subject multibarrier actuators may vary in the number of insulation layers, insulation thickness, dielectric strength, number of electrodes, electrode width, electrode gap, applied frequency, duty cycle, and voltage, for example.

Traditionally, in electrical glow discharge, a DC voltage potential is placed across two electrodes. If the voltage potential is gradually increased, at the breakdown voltage V_{B}, the current and the amount of excitation of the neutral gas becomes large enough to produce a visible plasma. According to Paschen's law, the breakdown voltage for a particular gas depends on the product (p.d) of the gas pressure and the distance between the electrodes. For any gas, there is a unique p.d value referred to as the Stoletow point where volumetric ionization is the maximum. The Stoletow point for air requires a minimum V_{B}=360 V and p.d=5.7 Torr-mm.

For flow control applications near atmospheric pressure, the allowable electrode spacing necessary for maximum volumetric ionization is d=0.077 mm. In many applications, this is an impractical limitation. One solution to this limitation comes from the development of RF glow discharge using an a.c. voltage potential across the electrodes. The frequency of the current should be such that within a period of the a.c. cycle, electrons travel to the electrodes and generate a charge, while the heavier ions do not. Based on reported experiments, the time-averaged plasma parameters for atmospheric glow discharge has air or other gases at 760±25 torr with relative humidity below 14%. A homogeneous glow can be maintained at about 3 to 10 kHz RF and rms electrode voltage between about 3 to 16 kV. For a gap distance of about 2-5 mm, the electron number density is ˜10¹⁷ m⁻³ and volumetric power dissipation is about 1 MW/m³.

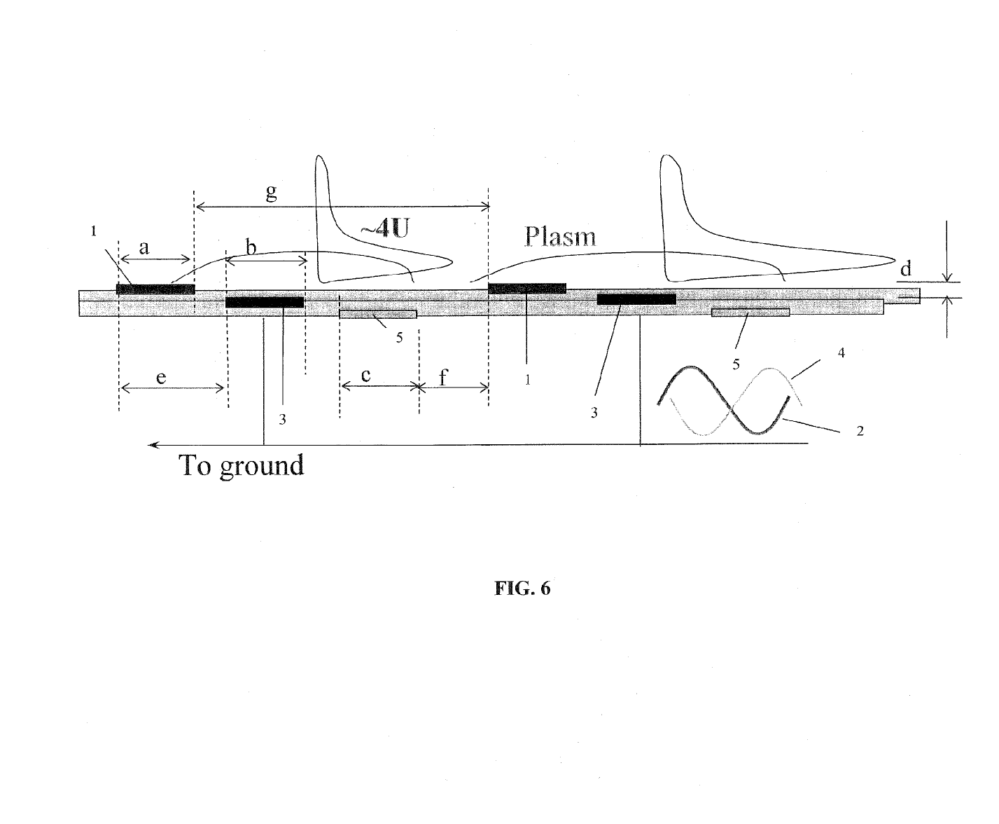

In an embodiment, a multilayer actuator is designed with several layers of dielectric, each incorporating an electrode. FIG. 6 shows a schematic for one embodiment of a bi-layer design as an example. The interelectrode distance d is kept at a few microns, thereby reducing or eliminating the kHz RF power requirement. In a preliminary experiment, the electrodes are powered with wall ac supply (60 Hz) through neon transformers and tested for a stable glow. The voltage pattern 2 shown at the bottom right of FIG. 6 is applied between the electrode 1 nearest the surface and the ground electrode 3 in the middle of the dielectric layers, while voltage pattern 4 is applied between the electrode 5 farthest from the surface and the ground electrode 3. The electrode 1 nearest the surface can be exposed to the fluid in the flow region or can have a coating separating the electrode 1 surface from the fluid in the flow region, depending on the fluid properties (e.g., electrical conductivity) and other design parameters. The stable discharge at single phase power induces a significantly large body force in an extended region, resulting in a possible order of magnitude increase in wall jet velocity with minimum arcing. Initial measurements show at least four times increase in the induced jet velocity (˜4 U). By using a set of phase lagged electrodes powered by a pulsed ac/dc supply, the induced wall jet can be improved by an order of magnitude, such as up to about 7-10 m/s.

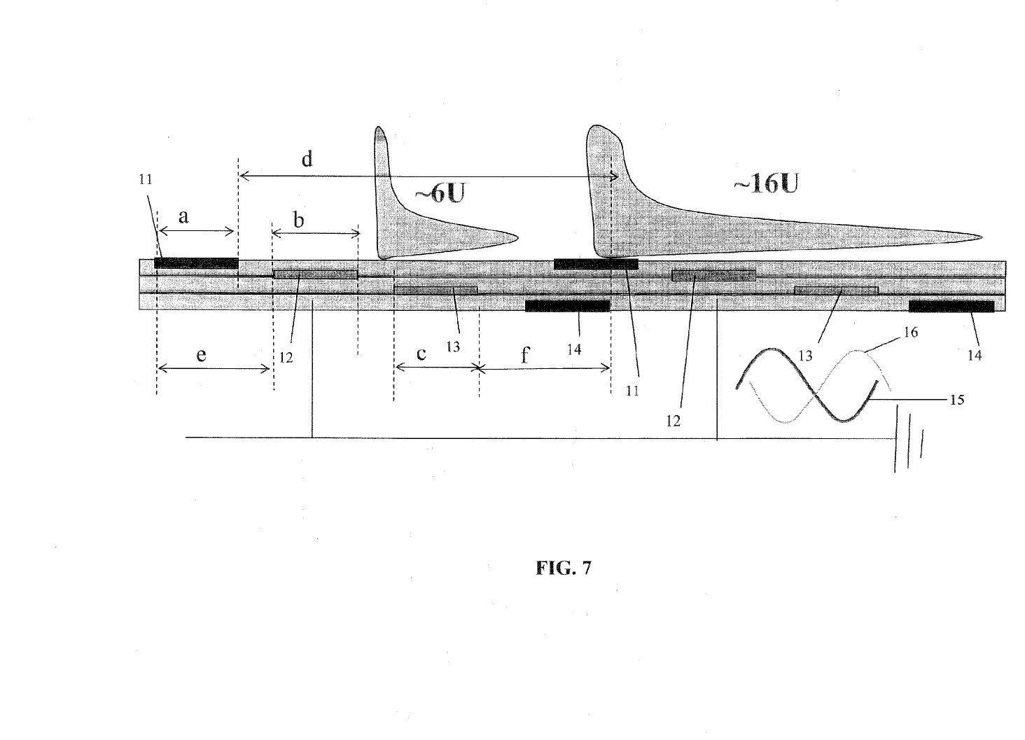

FIG. 7 shows an extremely large acceleration gain (i.e. >15 U induced velocity) for the multilayer arrangement. The voltage pattern 15 is applied between the electrode 11 nearest the surface and the ground electrode 13, while the voltage pattern 16 is applied between electrode 12 and the ground electrode 13. This may be achieved for the same energy density of plasma as of a monolayer arrangement. In additional embodiments, the number of layers can be increased to increase the plasma coated surface area. This means more EHD body force and resulting gas velocity are induced. Also, at this velocity, small scale turbulence may dominate the flow actuation process. Further, the micron level insulator thickness may influence the induced force. The electrodes can be positioned and driven in a variety of configurations and patterns, respectively, to induce a variety of flow patterns.

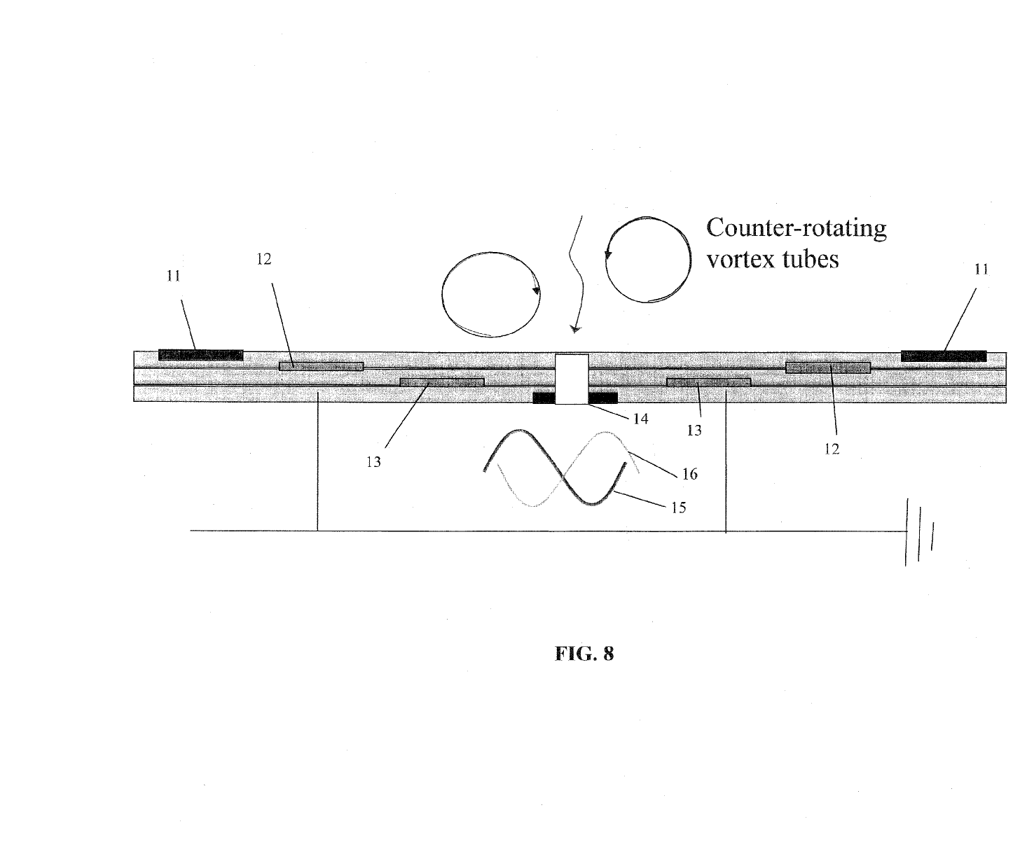

As an example, as shown in FIG. 8, flow actuation may be used for creating large or small counter rotating vortices. As discussed above, in embodiments, such vortices can be used to direct flow into or out of a flow passage. Based on the applied phase difference, these counter rotating vortex tubes can be slightly or greatly misaligned. In an embodiment, various vortex structures similar to those forming about different body shapes can be created. For example, the Karman vortex street for flow over a cylindrical object can be easily generated for electrode sets operating at a phase difference of p/2 with a select duty cycle. A powerful alternative for the synthetic jets can also be implemented with this design.

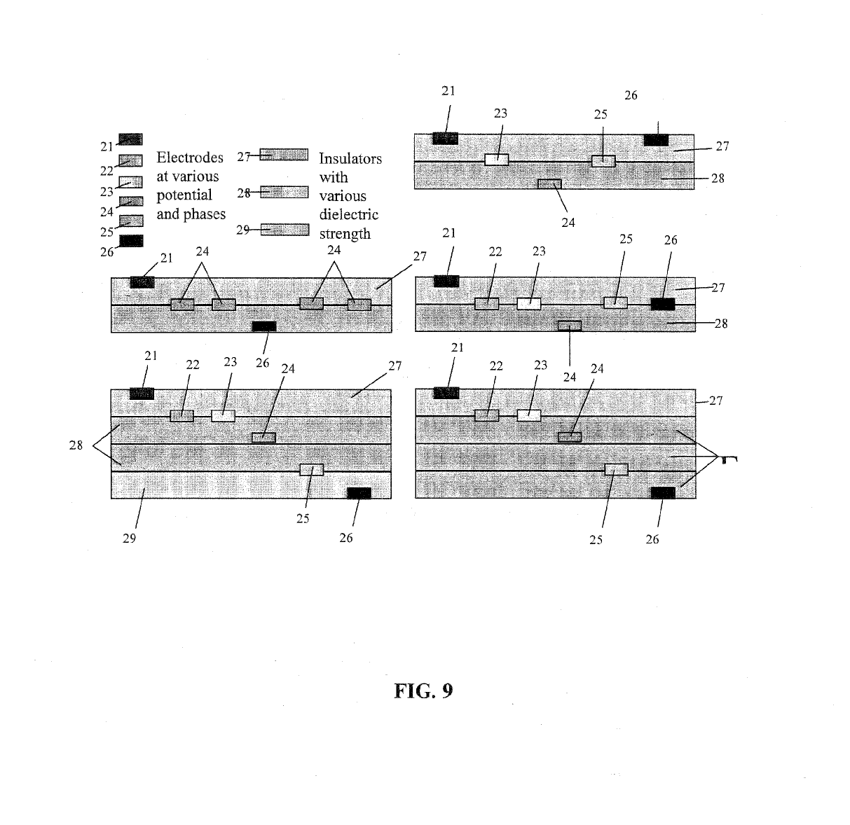

FIG. 9 illustrates several additional exemplary embodiments of the multilayer actuators in accordance with the subject invention, showing various geometric and electrical configurations. Various insulator materials such as KAPTON™ and TEFLON™ and their combinations, for example, can be utilized for minimum heat loss inside the dielectric material. Multilayer actuators of the present invention may have any number of insulation layers, insulation thicknesses, dielectric strengths, numbers of electrodes, electrode widths, inter-electrode gaps, applied frequencies, duty cycles, and voltages, for example. In an embodiment, such structures are applied to an interior surface of a channel or other flow passage to induce flow through the flow passage.

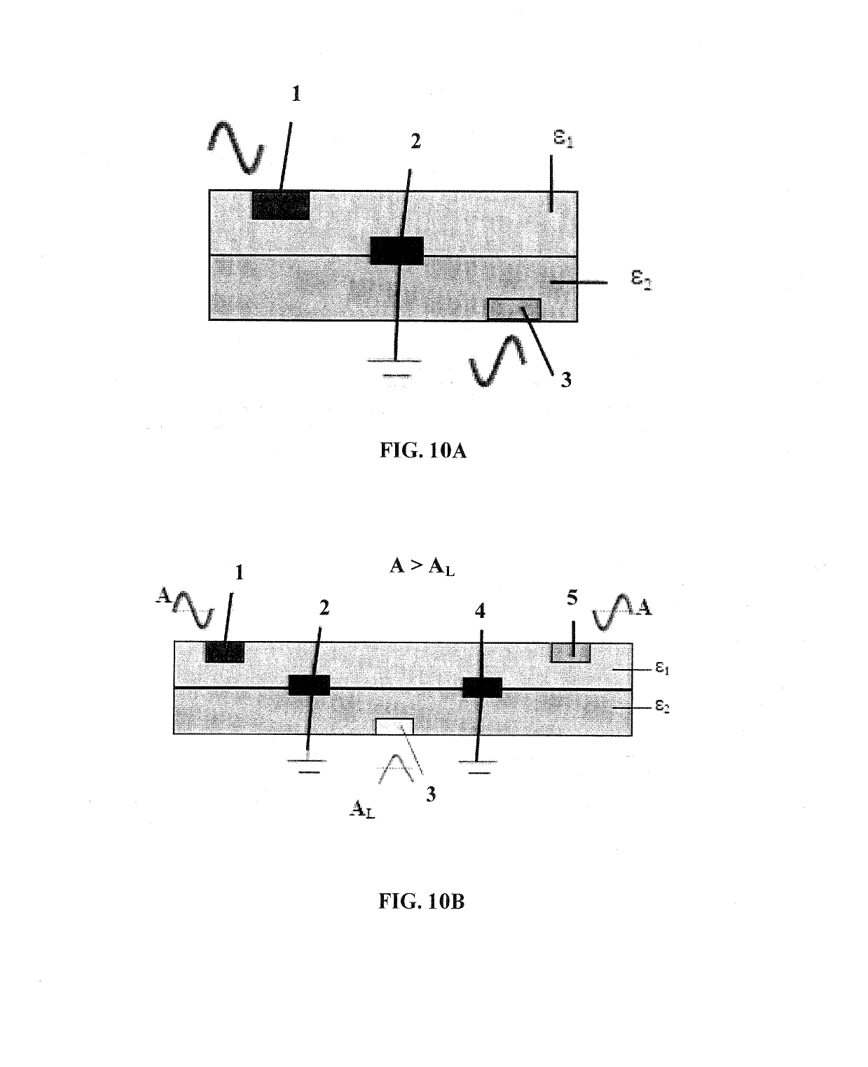

Referring to FIG. 10A, an embodiment is shown where the amplitude, A, and frequency, k, of the voltage applied between electrodes 1 and 2 and between electrodes 3 and 2 is the same. FIG. 10B shows an embodiment where the amplitude, A_{L}, and frequency, k_{L}, applied between electrodes 3 and 2 is different than the amplitude, A, and frequency applied between electrodes 1 and 2 and electrodes 5 and 4.

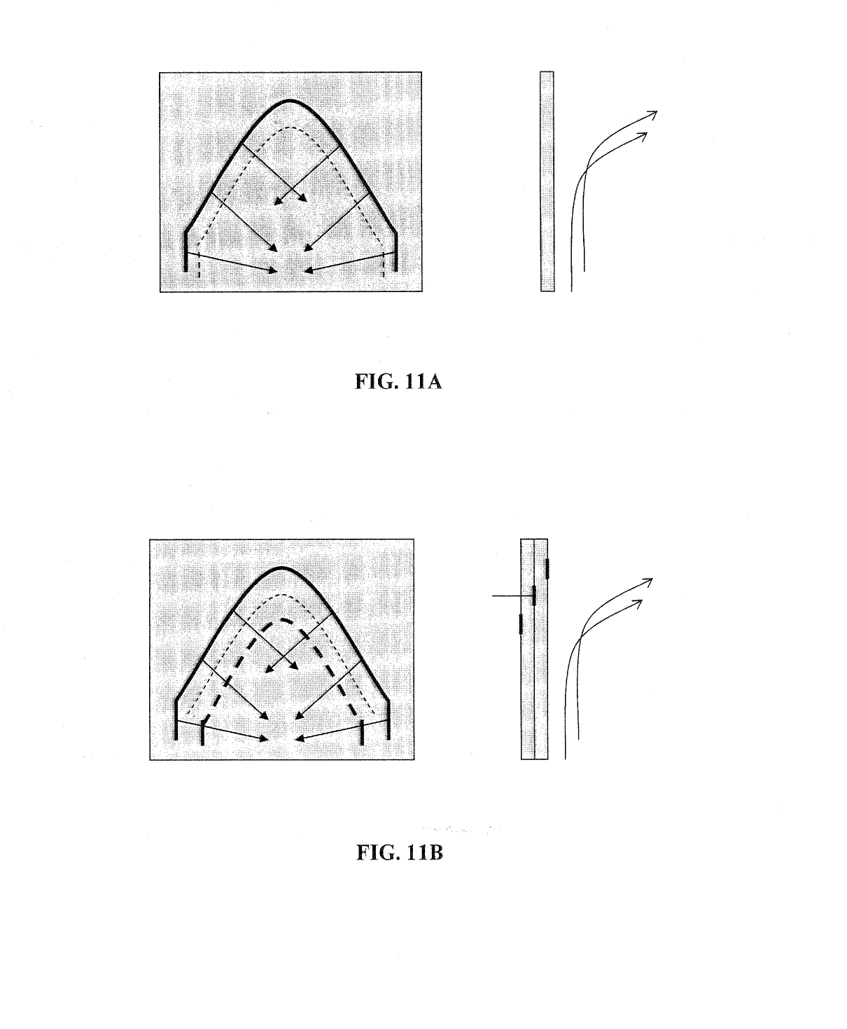

Additional embodiments of the invention can involve electrode structures incorporating curvatures or angles, such as triangle, square, or angle, with respect to the longitudinal dimension of the electrode pattern. Referring to FIGS. 11A and 11B, electrode patterns incorporating such curvatures are shown. FIG. 11A illustrates an electrode pattern having a cross-section as shown in the right side of FIG. 11A, where the longitudinal dimension of the electrode pattern incorporates a curvature, as shown on the left side of FIG. 11A. FIG. 11B shows an electrode pattern having a cross-section as shown in the right side of FIG. 11B, where the longitudinal dimension of the electrode pattern incorporates a curvature, as shown on the left side of FIG. 11B. The electrode patterns in FIGS. 11A and 11B can be used for bulk flow actuation and can create an upward body force away from the surface. The fluid receives a force from a plurality of directions such that fluid collides and is forced upward from surface or down toward surface. The arrows in FIGS. 11A and 11B show the direction of the flow when looking at a cross-section cut from the top to bottom of the respective electrode pattern with the ground electrode being on the inside of the curvature.

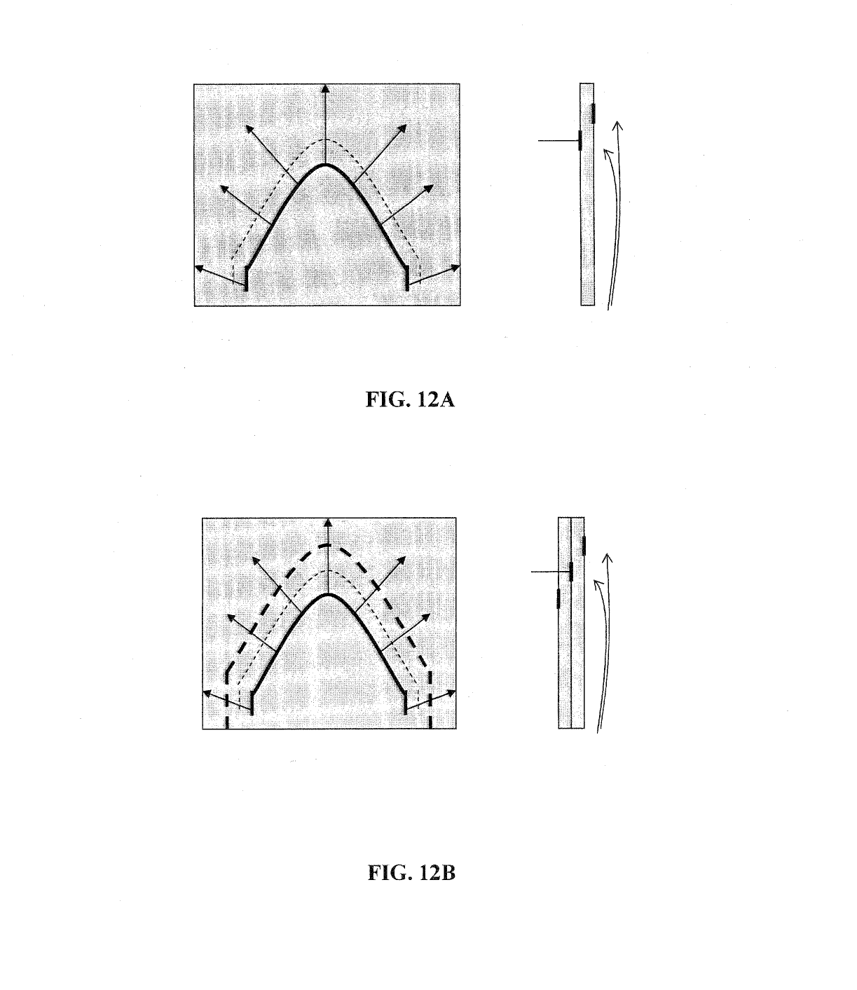

FIGS. 12A and 12B show the electrode patterns of FIGS. 11A and 11B, respectively, with the ground electrode being on the outside of the curvature in FIG. 12A and the electrode driven to create a body force from the inner electrode to the outer electrode. The arrows shown in FIGS. 12A and 12B show the flow created by driving the electrode structures in this manner.

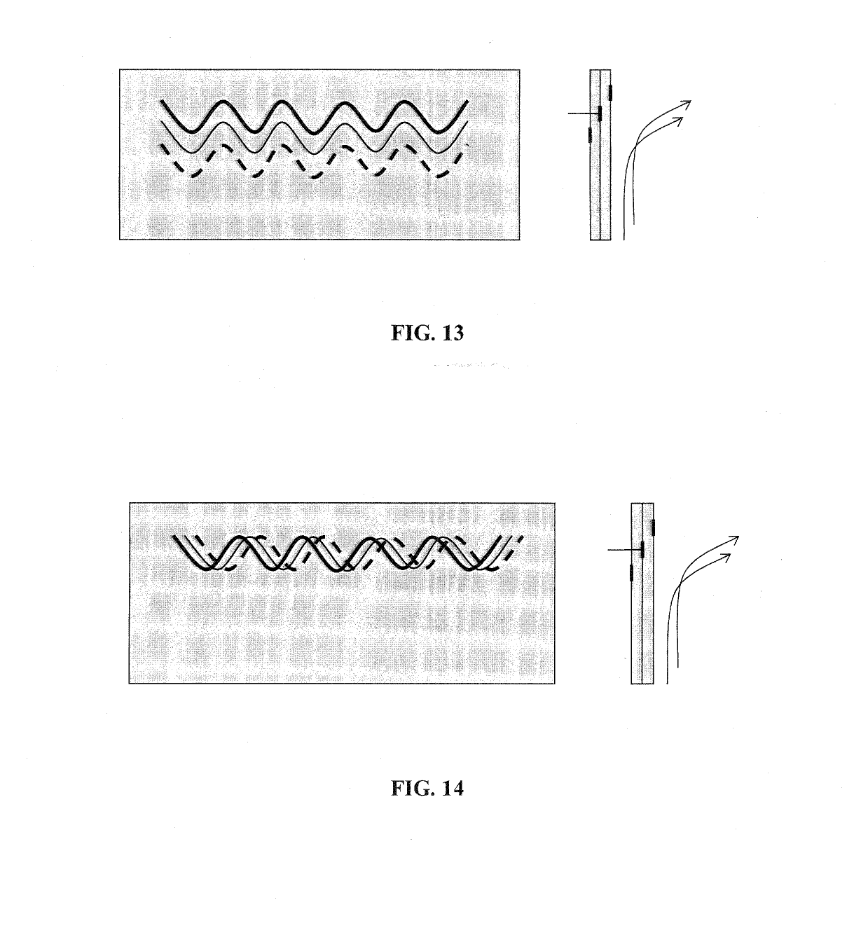

FIG. 13 shows an electrode structure having a serpentine turbulator design in the longitudinal dimension. The arrows on the right side show the flow for a cross-section cut from top to bottom where the electrodes are driven to produce a body force from the outer electrode to the inner electrode with respect to one of the curved sections.

FIG. 14 shows another embodiment having a serpentine turbulator design in the longitudinal dimension where the electrodes have a different orientation from the electrode pattern in FIG. 13. The arrows show the flow for a cross-section out from top to bottom at a location where the body force is away from the surface.

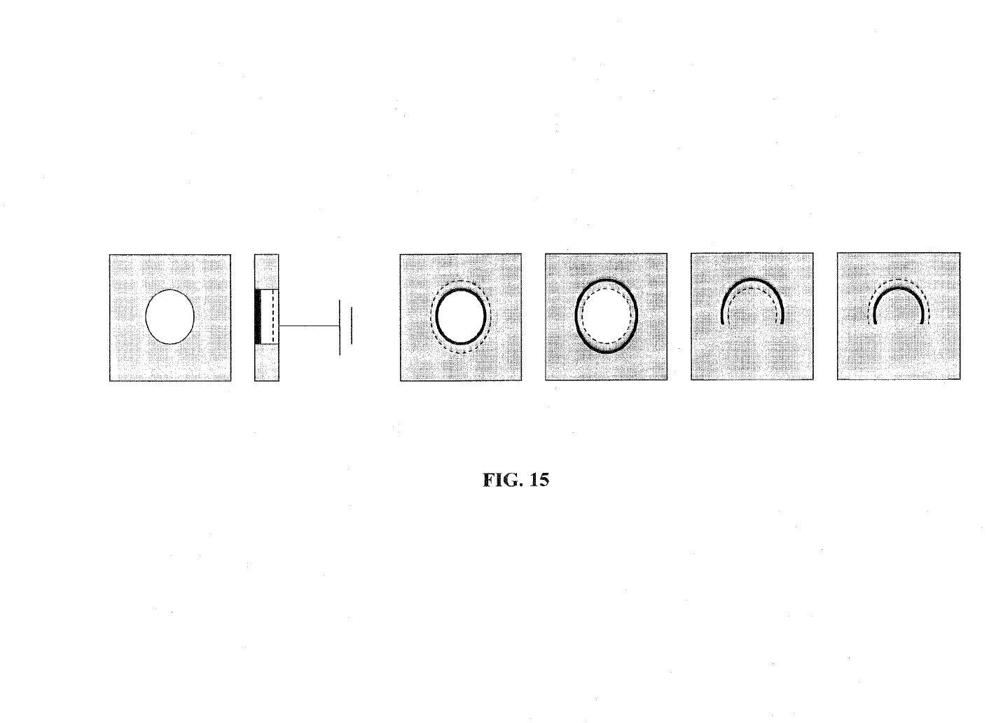

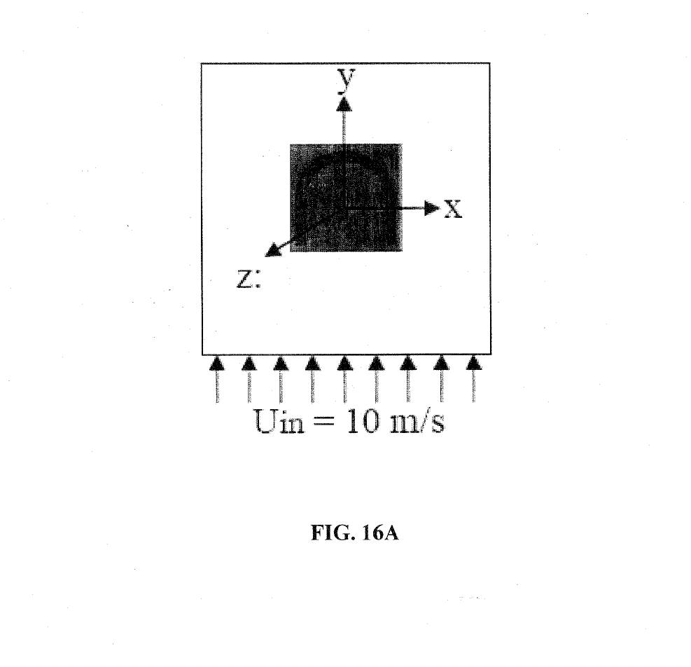

A variety of curvatures can be implemented in accordance with the subject invention. FIG. 15 shows additional embodiments of electrode patterns incorporating curvatures in the longitudinal dimension of the electrodes, including an electrode pattern surrounding an aperture in the substrate and an electrode pattern in the shape of a half circle. Other shapes include, but are not limited to, angles, triangles, rectangles, polygons, and other shapes that vary from straight. The electrode pattern surrounding the aperture can be designed and driven to pull flow up through the aperture or driven to force flow into the aperture. Likewise, the electrode pattern in the half circle can be designed and driven to force flow away from the substrate or designed and driven to pull flow toward the substrate.

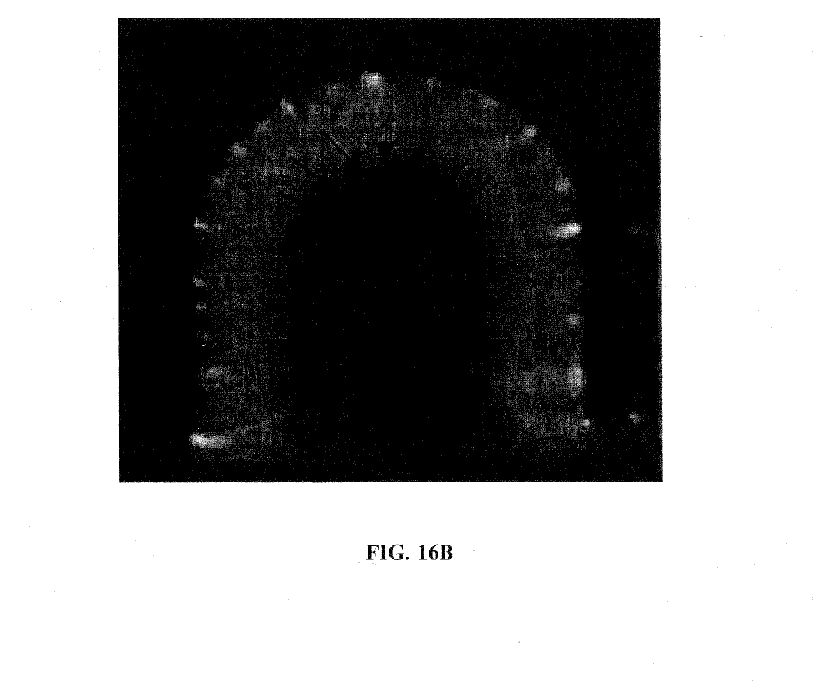

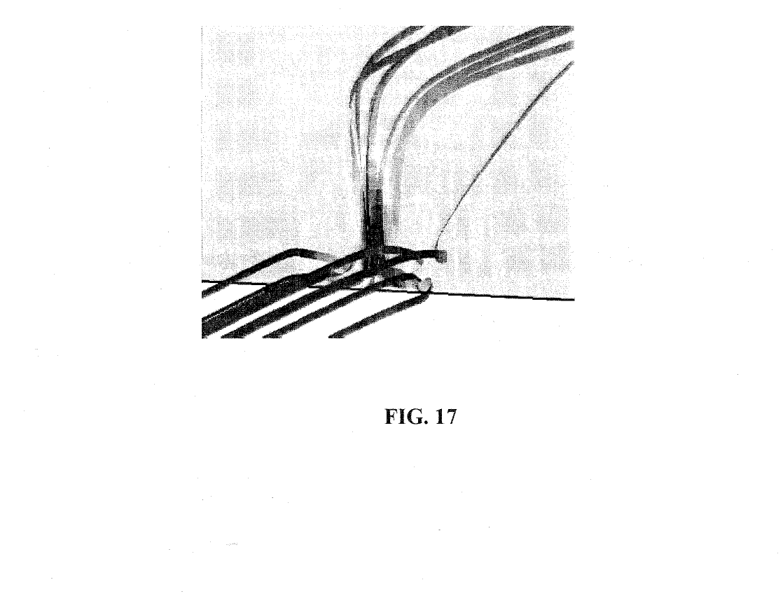

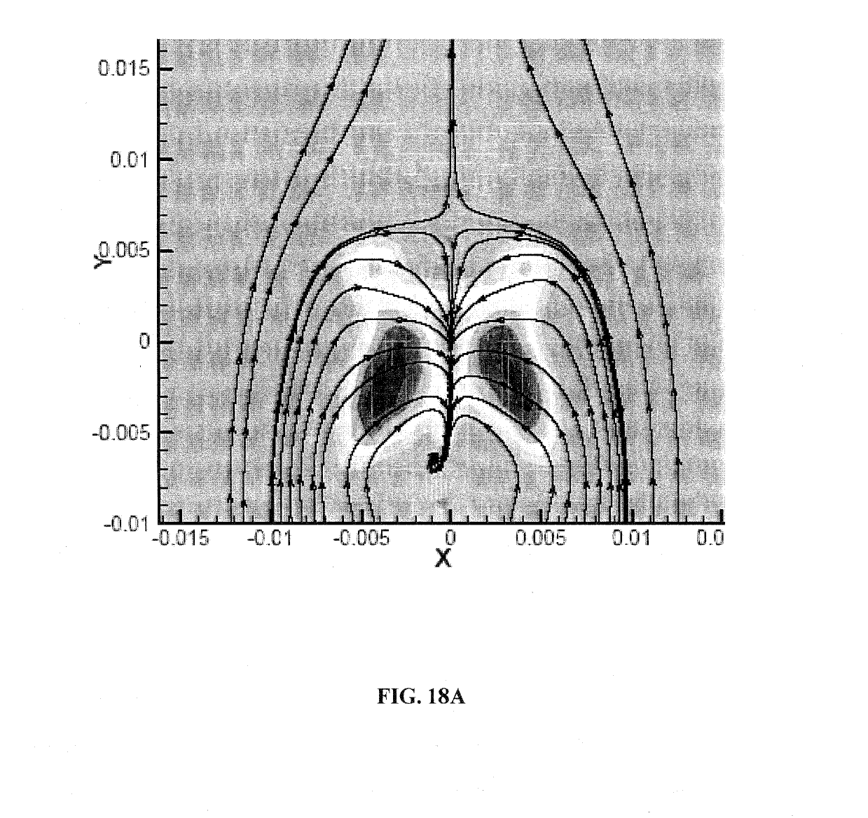

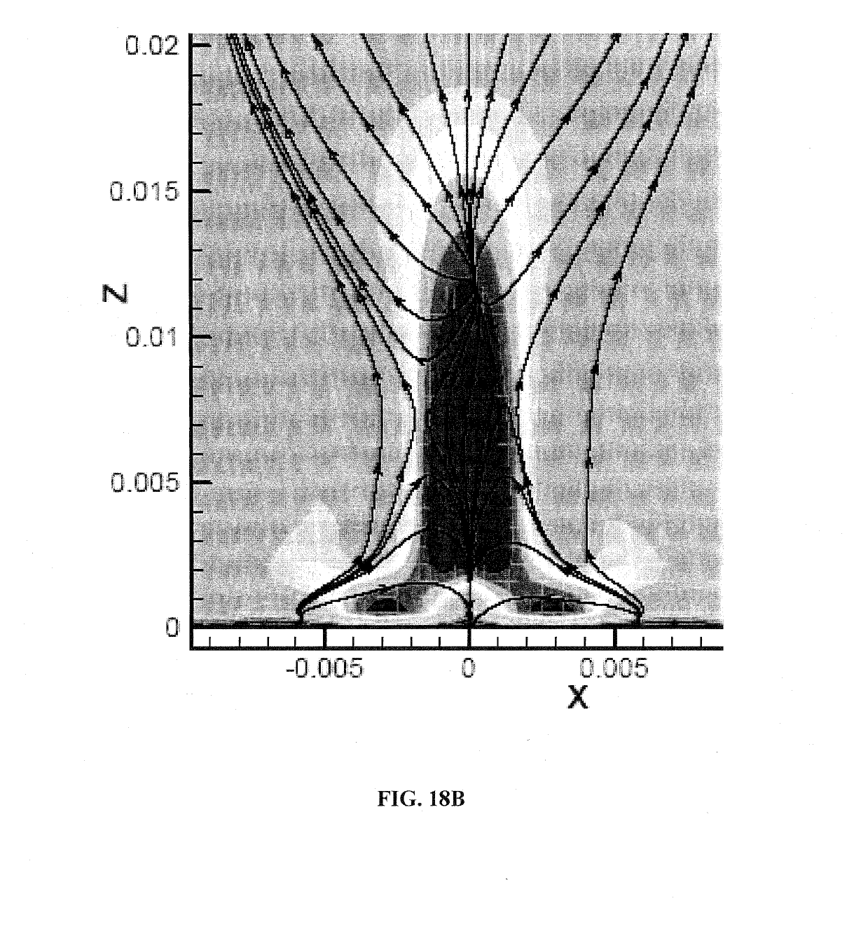

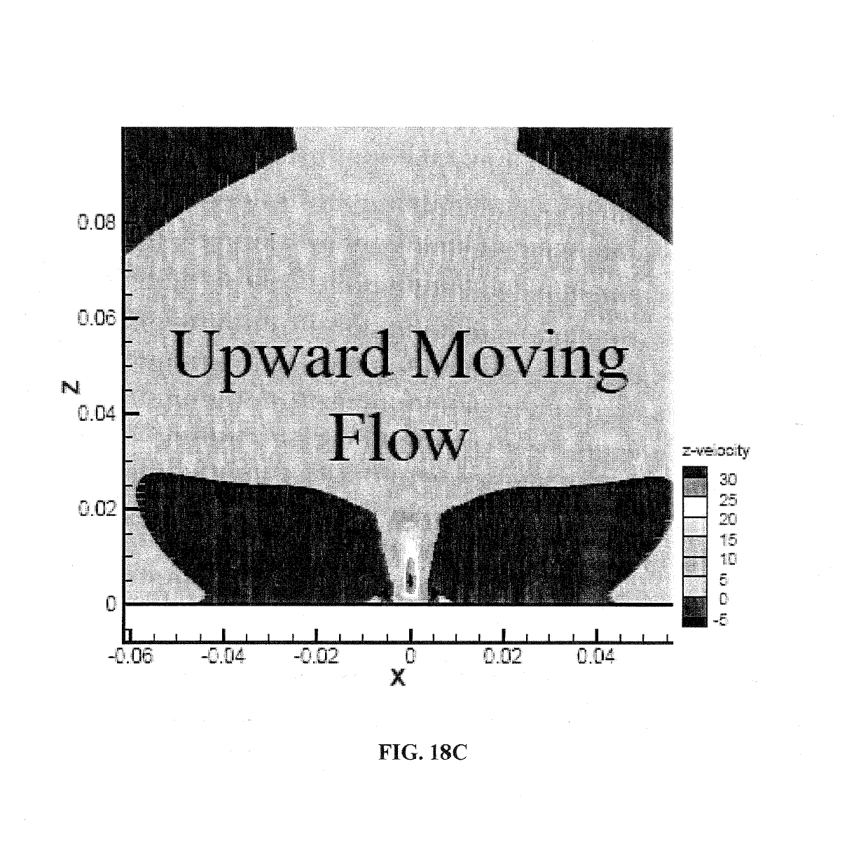

FIGS. 16A and 16B show an electrode pattern similar to the pattern in FIG. 11A and the corresponding glow pattern, respectively. The electrode pattern of FIG. 16A is driven to create the body force from the outer electrode to the inner electrode. FIG. 17 shows flow traces, and FIGS. 18A-18C show data illustrating the upward body force produced by this electrode pattern when driven in this matter where the summation of the flow-force creates an upward flow force.

In embodiments, such electrode patterns can be positioned on various surfaces of a wind tunnel and powered to control flow of a fluid into, out of, or through the wind tunnel. Various illustrative examples are provided and discussed below. Other configurations are also possible.

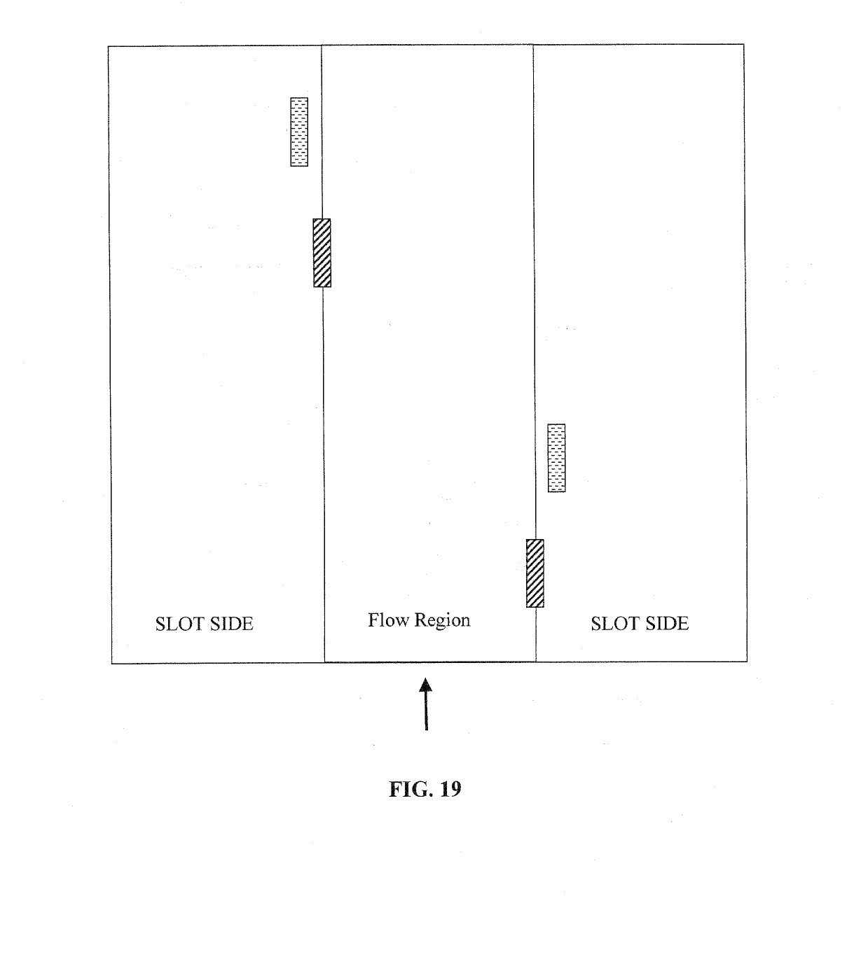

FIG. 19 shows a schematic diagram of a flow passage, such as a channel or other flow passage, configured to use a DBD in accordance with an embodiment of the subject invention. In the embodiment shown, two pairs of electrodes are foamed in surfaces of the flow passage. In an embodiment, the pairs of electrodes are powered to produce a DBD that induces flow of a fluid through the flow passage. In an embodiment, the pairs of electrodes are powered in parallel. In an embodiment, the pairs of electrodes are powered sequentially. In an embodiment, multilayer actuators, such as the multilayer actuators discussed above, are formed in surfaces of the flow passage.

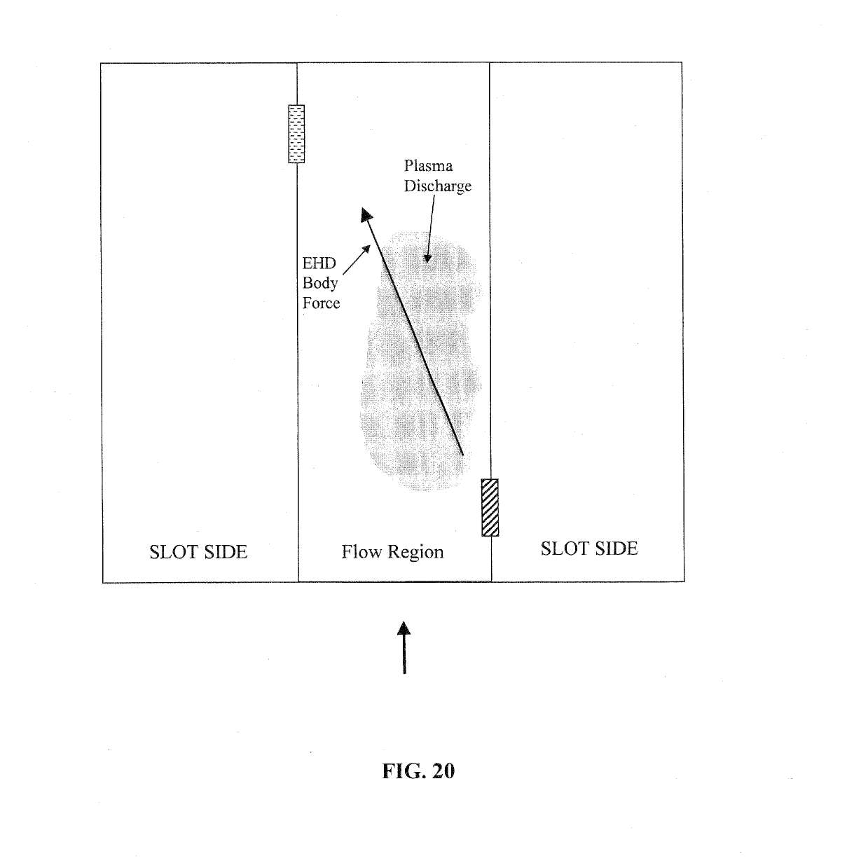

FIG. 20 shows a schematic diagram of a flow passage, such as a channel or other flow passage, using a volumetric plasma discharge in accordance with an embodiment of the subject invention. In the embodiment shown, a pair of electrodes is formed in surfaces of the flow passage. In an embodiment, the pairs of electrodes are powered to generate a volumetric plasma discharge. The volumetric discharge in turn produces an EHD body force that induces flow of a fluid through the flow passage.

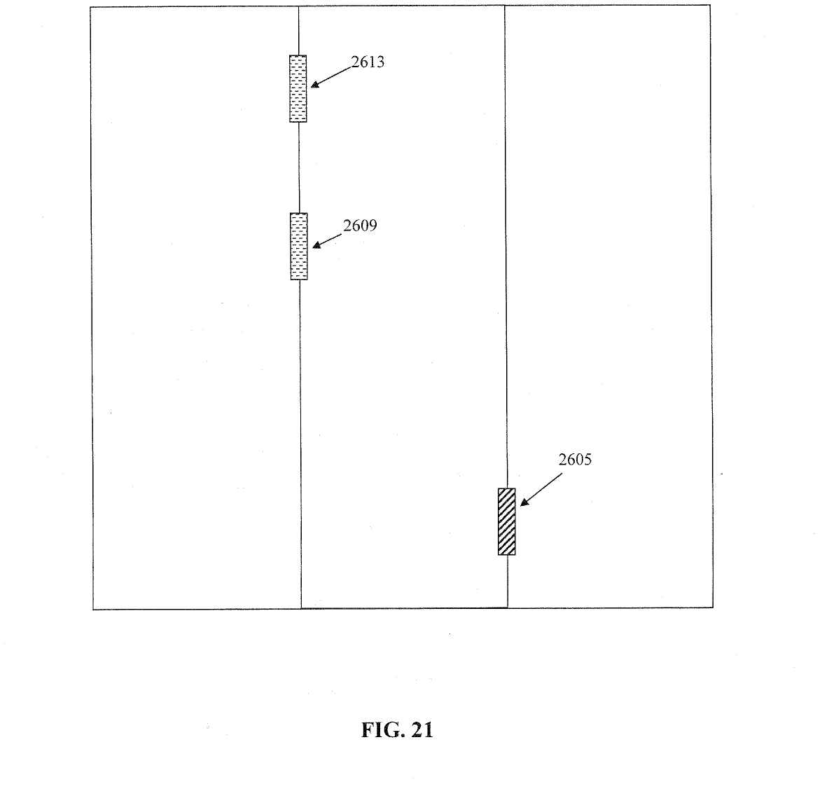

FIG. 21 shows a schematic diagram of a flow passage, such as a channel or other flow passage, configured to use volumetric plasma discharges in accordance with another embodiment of the subject invention. In the embodiment shown, three electrodes 2605, 2609, 2613 are formed on surfaces of the flow passage. In an embodiment, the electrodes can be powered in pairs to produce volumetric plasma discharges within the flow passage. In an embodiment, the electrode 2605 is first powered with the electrode 2609 to produce a first volumetric plasma discharge within the flow passage. The electrode 2605 is later powered with the electrode 2613 to produce a second volumetric plasma discharge further down the flow passage.

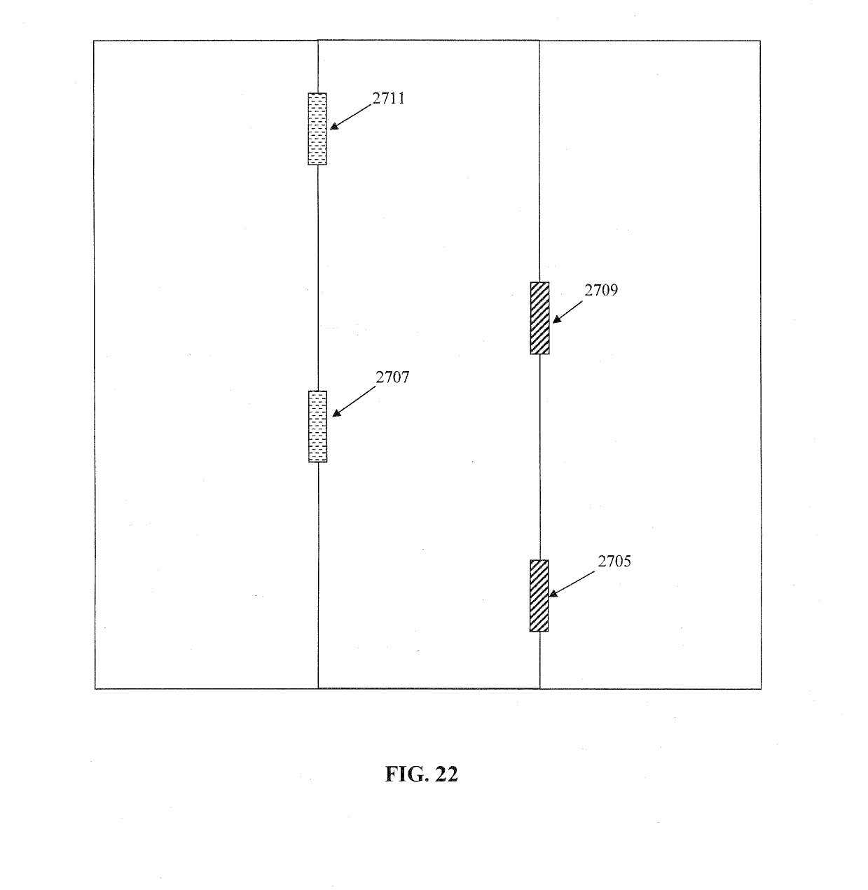

FIG. 22 shows a schematic diagram of a flow passage, such as a channel or other flow passage, configured to use volumetric plasma discharges in accordance with yet another embodiment of the subject invention. In the embodiment shown, four electrodes 2705, 2707, 2709, 2711 are formed on surfaces of the flow passage. In an embodiment, the electrodes can be powered in pairs to produce volumetric plasma discharges within the flow passage. In an embodiment, the electrode 2705 is first powered with the electrode 2707 to produce a first volumetric plasma discharge within the flow passage. The electrode 2709 is later powered with the electrode 2711 to produce a second volumetric plasma discharge further down the flow passage. In another embodiment, the pairs of electrodes (2705, 2707) and (2709, 2711) are powered simultaneously to produce simultaneous plasma discharges at multiple positions within the flow passage. In a further embodiment, the electrode 2707 is also powered with the electrode 2709 to produce a third volumetric plasma discharge. In an embodiment, the electrodes are powered in a sequence of pairs (2705, 2707), (2707, 2709), (2709, 2711) to produce a series of three plasma discharges progressing down the flow passage from the electrode 2705 toward the electrode 2711. In another embodiment, the electrode pairs (2705, 2707) and (2709, 2711) are powered simultaneously to produce simultaneous plasma discharges, and the electrode pair (2707, 2709) is later powered to produce a later plasma discharge. In an embodiment, the pattern of powering pairs of electrodes is repeated to produce repeated plasma discharges. In an embodiment, the repeated plasma discharges generate EHD body forces that induce flow of a fluid from the electrode 2705 toward the electrode 2711.

FIG. 23 shows various flow passage configurations in accordance with embodiments of the subject invention. The configurations shown can be applied to various flow passages, such as the channels, micro channels, or other flow passages discussed above. As shown, such flow passages can widen or narrow linearly or geometrically at one or both ends. The flow passages can also narrow or widen along the entire length of the flow passage. Such change can also be linear or geometric. As shown in FIG. 23E, such flow passages can also have convex protrusions on one or both ends. In other embodiments, concave structures can also be formed at one or both ends of such flow passages. Such structures can have various concave and/or convex shapes including square, rectangular, rounded, circular, elliptical, polygonal, among other shapes. In an embodiment, such structures facilitate flow of a fluid through the flow passage.

FIG. 24 shows various flow passage cross-sections in accordance with embodiments of the subject invention. The cross-sections shown can be used with various flow passages, such as the channels, micro channels, or other flow passages discussed above. A variety of channel cross-sections can be implemented. Examples of cross-sections include, but are not limited to, circular, square, rectangular, polygonal, hexagonal, or parallel plates or curves.

Such flow passages can have various cross-sections. In an embodiment, a channel is formed having internal structures formed therein to further control flow through the channel. For example, a honey comb structure can be used as shown in FIG. 24F. In another embodiment, one or more screens, vanes, or structures can be positioned in the flow passage. In an embodiment, a square screen can be used as shown in FIG. 24E. In another embodiment, a honey comb screen is used as shown in FIG. 24F. Other screen configurations are possible as known in the art.

In embodiments of the subject invention, EHD body forces can be used to pump fluid in a micro channel or other small flow passage without any mechanical components. The actuators of the micropump according to some embodiments of the present invention can operate using (pulsed) dc and ac power supply and can apply large electrohydrodynamic (EHD) forces in a relatively precise and self-limiting manner Further embodiments can have rapid switch-on/off capabilities. Specific embodiments can operate without any moving parts.

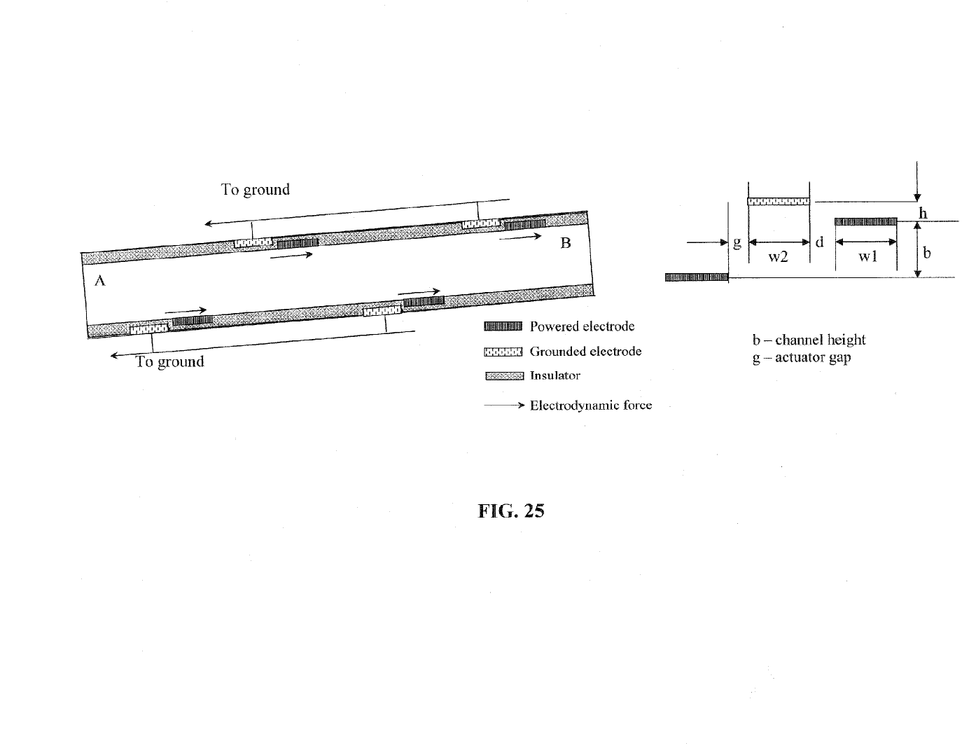

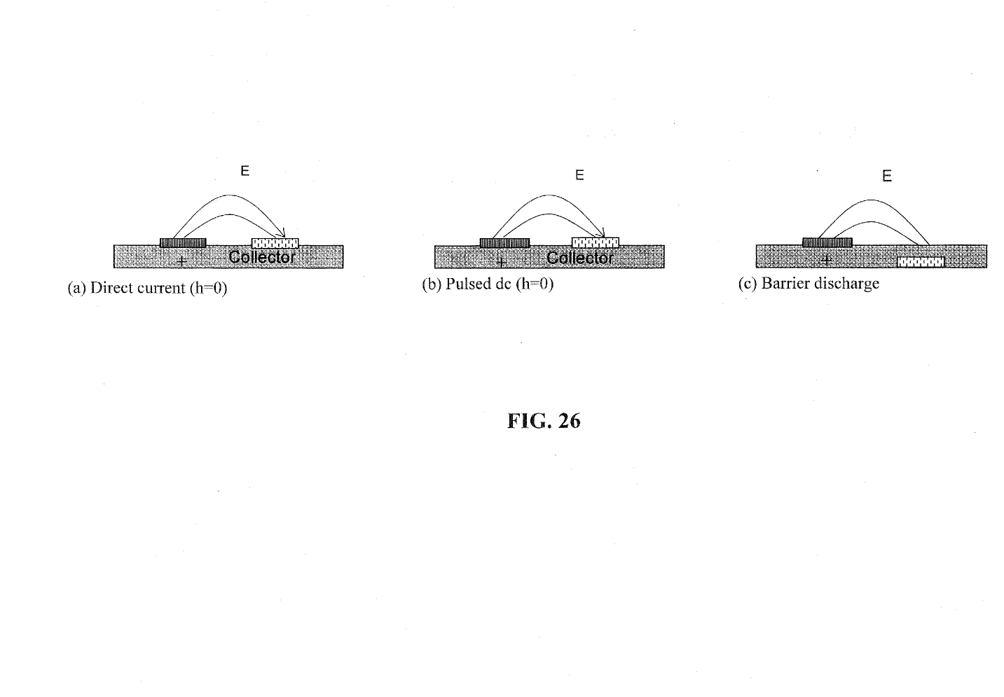

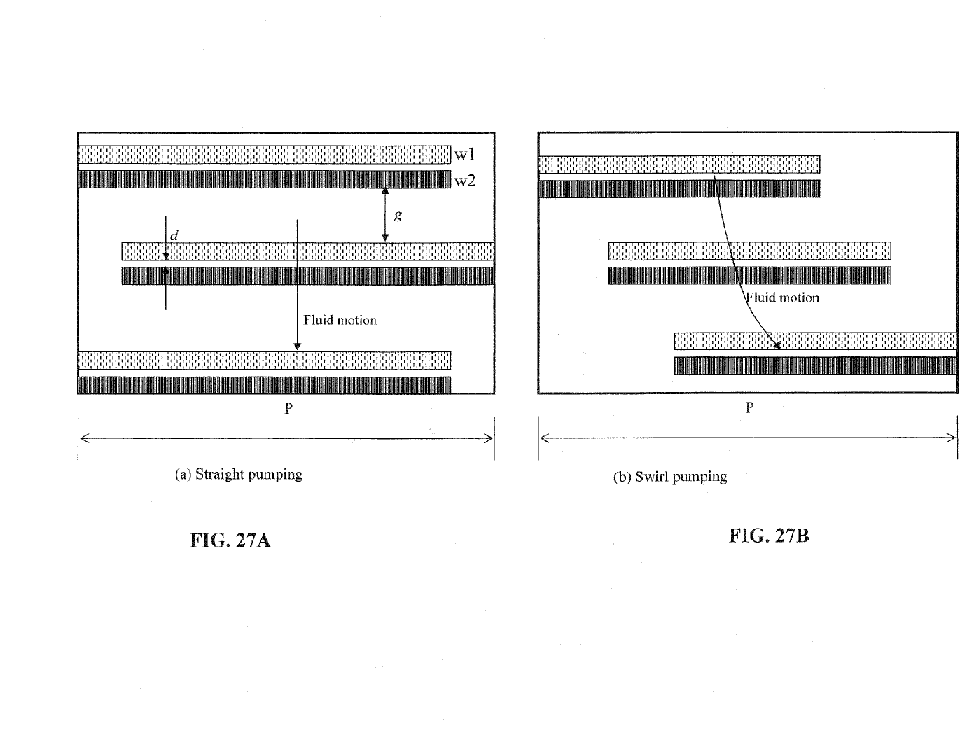

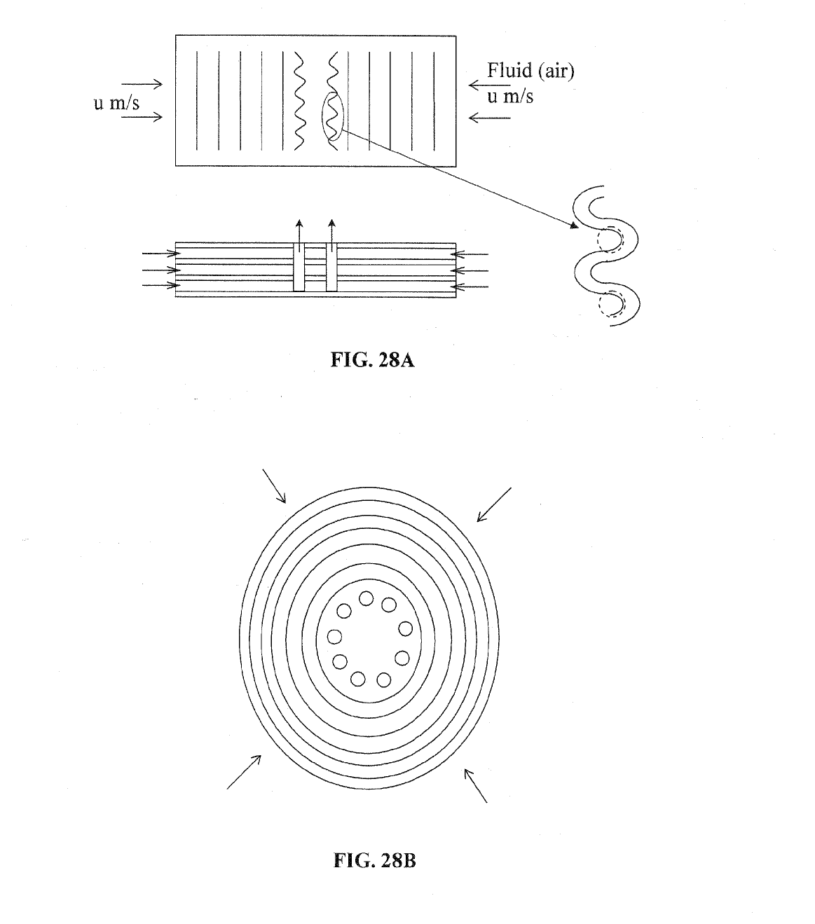

As discussed above in relation to FIG. 24, a variety of flow passage cross-sections can be implemented. FIG. 25 can represent a cross-section through a flow passage, such as a channel or other flow passage, having a circular, rectangular, or other shape cross-section, or a parallel plate configuration. FIGS. 27A and 27B can represent a laid open flow passage having a circular, rectangular, or other shaped cross-section, or a plate of a parallel plate configuration. FIGS. 28A and 28B show embodiments incorporating parallel plate flow passages. The top portion of FIG. 28A shows a top of one of the plates of a parallel plate flow passage device. Each line shown represents an electrode pair, such as the electrode pairs shown in FIG. 26, with the blown-up drawing section showing a curved electrode pair that can act to direct the flow of the fluid away from the surface. The fluid located in the dotted region of the blown-up drawing section experiences forces from the electrode pair converging from the curved structure of the electrode pairs such that when the fluid is pushed away from the curved electrode pair, the fluid is pushed away from the surface of the plate. The dotted region of the blown-up drawing section can also have an aperture through the plate such that when fluid is pushed up from the plate below, the fluid travels through the plate and is continued to be pushed up. The bottom portion of FIG. 28A shows a side view of a stack of parallel plates having apertures through the top three plates such that fluid flows from the right and left, due to the force from multiple electrode pairs and is directed up as shown by the arrows exiting the apertures in the top plate.

The plates in the stack of plates in FIG. 28A can have a variety of shapes, such as square, rectangular, oval, circular, hexagonal, or polygonal. FIG. 28B shows a specific embodiment having oval shaped plates. FIG. 28B shows multiple apertures through one of the plates, which can optionally coincide with apertures in other plates. Various configurations of apertures in the plates can be implemented. FIG. 28B also shows concentric electrode pairs that create forces on the fluid, for example, to push the fluid toward the center of the device. In an embodiment, fluid is pulled in along the outer edges of the oval plates, pushed toward the center, and then directed up through the apertures. In a specific embodiment, the spacing between the plates shown in FIGS. 28A and 28B can be such that electrode pairs located on the surface of one or both plates creating the parallel plate flow orifices can create a bulk flow effect to move the fluid through the parallel plate flow orifice.

FIG. 25 shows a longitudinal cross-section of a flow passage, such as a channel or other flow passage, according to an embodiment of the present invention. In one embodiment, the flow passage material can be an insulator and can have a channel height b. The pumping of fluids through the flow passage may be accomplished utilizing electromagnetic effects such as an electrohydrodynamic body force and/or a magnetohydrodynamic effect through a Lorentz force. The forces can be induced using dynamic barrier discharge (DBD) electrodes. As illustrated in FIG. 25, the flow passage can be asymmetrically coated with electrode pairs. An electrode pair including a powered electrode having a width w1 and a grounded electrode having a width w2 can be formed adjacent each other and separated by a distance d. The electrode pair can be a DBD electrode pair, where the grounded electrode and the powered electrode can be separated a distance h by an insulator. In an embodiment, the electrode pair is separated by a wall of the flow passage, or portion thereof. These electrode pairs can be formed at intervals along the flow passage. For example, the electrode pairs can be asymmetrically formed along the flow passage at intervals with an actuator gap g.

In an embodiment, the powered electrodes can be exposed along the inner perimeter of the flow passage. In another embodiment, the powered electrodes can have a coating separating the powered electrode from the fluid. Various embodiments can be applied to any fluids that can be ionized, such as air, gases, and liquids. For electrically non-conductive fluids, the electrode of the electrode pair near the surface can be exposed to the fluid, but a cover can be positioned over the electrode if desired. For electrically conductive fluids, a cover, such as dielectric coating, can be placed over the electrode near the surface. This cover can improve safety.

In operation, a small plasma discharge can be generated in the vicinity of the exposed (powered) electrode to induce an amount of electrohydrodynamic (EHD) body force to push gas/liquid in a certain direction. A magnetic field can also be used to induce additional magnetohydrodynamic (MHD) effect through Lorentz force. In a specific embodiment, the magnetic field can be oriented such that the current flow of the gas and/or liquid crossed with the direction of the magnetic field creates a force away from the surface of the flow passage, so as to pinch the fluid along. The net result can be very efficient movement of fluid through the flow passage.

The electrode pairs can be powered and formed in various configurations. FIG. 26 shows examples of electrode arrangements that can be incorporated in embodiments of the present invention. FIGS. 26A and 26B show an electrode pair with both electrodes on the same surface, where h=0. FIG. 26A illustrates the electrode pair as being maintained at a potential bias using steady direct current; and FIG. 26B illustrates the electrode pair as being maintained at a potential bias using pulsed direct current. In another embodiment, alternating current can be used. FIG. 26C shows an electrode pair separated by an insulator layer. The electrode pair of FIG. 26C can also be referred to as barrier discharge electrodes where one electrode can be powered with dc or ac operating at a radio frequency. The powered electrode can be exposed to the gas, but embodiments can be provided where the powered electrode is not exposed to the gas.

In operation, electric forces can be generated between the electrodes. As the applied voltage becomes sufficiently large for a given interelectrode distance d and pressure p, the dielectric surface adjacent to the electrode can produce a surface discharge weakly ionizing the surrounding gas. The plasma can cause an energy exchange between charged and neutral species. In this discharge, microfilaments of nanosecond duration with many current pulses in a half cycle can maintain the optical glow. Due to a combination of electrodynamic and collisional processes, charge separated particles induce the gas particles to move.

FIGS. 27A-27B show details along the inner perimeter of a flow passage. FIG. 27A shows an example of a periodic pattern for implementing straight pumping. FIG. 27B shows an example of a step pattern for swirl pumping. In a specific embodiment, each electrode pair along the length of the flow passage can rotate with respect to the electrode pair before it, around the longitudinal axis of the flow passage, as shown in FIG. 27B, so as to create a swirl flow pattern.

Various flow passage configurations can be used with the subject invention as discussed above including various dimensions, geometry, electrode arrangements, and powering schemes.

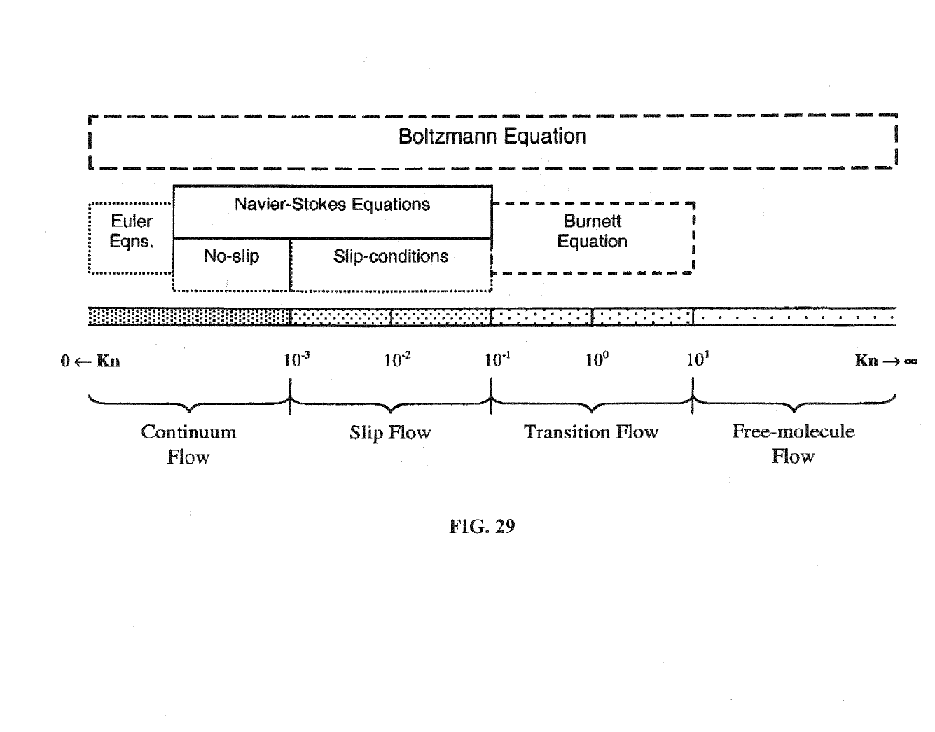

FIG. 29 shows Knudsen number regimes for modeling fluid flow through a flow passage in accordance with embodiments of the subject invention. Subrata Roy and Reni Raju describe modeling fluid flow through such structures in Roy & Raju, Modeling Gas Flow through Microchannels and Nanopores, 93 Journal of Applied Physics 4870 (2003) and Raju & Roy, Modeling Single Component Fluid Transport through Micro Channels and Free Molecule Micro-Resistojet, AIAA-2004-1342 (2004), which are hereby incorporated by reference for that purpose.

The paper by Raju & Roy, Modeling Single Component Fluid Transport through Micro Channels and Free Molecule Micro-Resistojet, AIAA-2004-1342 (2004) also discusses fabrication of MEMS devices, and is hereby incorporated by reference for that purpose. As will be understood by one skilled in the art, in accordance with standard MEMS fabrication techniques, micro channels can be fabricated by building up and/or etching materials deposited on a substrate. Electrodes can be incorporated into such layers to achieve the configurations shown and discussed above. Other methods of achieving such configurations may be possible and can be used with the subject invention.

In an embodiment of the subject invention, a testing system is provided for testing a subject in a wind tunnel. In an embodiment, the testing system includes one or more computers programmed to control the powering of one or more actuators positioned on, in, or near the wind tunnel as described above. In an embodiment, voltages are applied to different electrodes at different times in order to control the flow of fluid into, out of, or through the wind tunnel. In an embodiment, the one or more actuators are powered in phases as discussed above. In an embodiment, a controller is provided that controls the timing of voltage application to the electrodes. In an embodiment, the actuators are powered according to instructions embodied on one or more computer-readable media as described below. In an embodiment, the testing system incorporates a processing system as described below.

In an embodiment, the one or more computers of the testing system are configured to take one or more measurements via at least one measuring device as discussed above. In a further embodiment, the testing system is further configured to process the measurements to obtain useful data. In a further embodiment, the course of testing controlled by the testing system is varied by the testing system depending on the measurements or data obtained. In an embodiment, the testing system is operates according to instructions embodied on one or more computer-readable media as described below.

In an embodiment, one or more of steps of a method for testing a subject in a wind tunnel are preformed by one or more suitably programmed computers. In a particular embodiment, at least one of the controlling or processing steps is preformed by the one or more suitably programmed computers. Computer-executable instructions for performing these steps can be embodied on one or more computer-readable media as described below. In an embodiment, the one or more suitably programmed computers incorporate a processing system as described below. In an embodiment, the processing system is part of a testing system as described above.

In an embodiment, a method of applying a fluid flow to a test subject can include: providing a wind tunnel comprising a flow passage having at least one surface; providing at least one pair of electrodes, wherein each electrode of each pair of electrodes is positioned on or proximate the at least one surface of the wind tunnel; introducing a fluid into the flow passage; applying a voltage potential across one or more of the at least one pair of electrodes to produce a plasma discharge in the flow passage, such that when the plasma discharge is produced an electrohydrodynamic body force is generated that induces a fluid flow within the flow passage; and positioning the test subject in a path of the fluid flow. In an embodiment, the fluid within the flow passage flows at a speed of no more than 15 meters per second. In a further embodiment, the fluid within the flow passage flows at a speed of no more than 10 meters per second. In a further embodiment, the fluid within the flow passage flows at a speed of no more than 5 meters per second.

In an embodiment, the fluid within the flow passage flows at a speed of at least 1 mm/s. In a further embodiment, the fluid within the flow passage flows at a speed of at least 1 cm/s. In a further embodiment, the fluid within the flow passage flows at a speed of at least 10 cm/s. In a further embodiment, the fluid within the flow passage flows at a speed of at least 1 m/s. In a further embodiment, the fluid within the flow passage flows at a speed in a range of 1 mm/s to 1 cm/s. In a further embodiment, the fluid within the flow passage flows at a speed in a range of 1 mm/s to 1 m/s. In a further embodiment, the fluid within the flow passage flows at a speed in a range of 1 cm/s to 10 cm/s. In a further embodiment, the fluid within the flow passage flows at a speed in a range of 1 cm/s to 1 m/s. In a further embodiment, the fluid within the flow passage flows at a speed in a range of 1 m/s to 10 cm/s. In a further embodiment, the fluid within the flow passage flows at a speed in a range of 1 m/s to 10 m/s. In a further embodiment, the fluid within the flow passage flows at a speed in a range of 1 mm/s to 5 m/s. In a further embodiment, the fluid within the flow passage flows at a speed in a range of 1 mm/s to 10 m/s. In a further embodiment, the fluid within the flow passage flows at a speed in a range of 1 mm/s to 15 m/s.

In an embodiment, the wind tunnel can have a cross-sectional area of 1 mm² to 22,500 mm². In a further embodiment, the wind tunnel can have a cross-sectional area of 100 mm² to 2,500 mm². In a further embodiment, the wind tunnel can have a cross-sectional area of 1 mm² to 2,500 mm². In a further embodiment, the wind tunnel can have a cross-sectional area of 100 mm² to 22,500 mm².

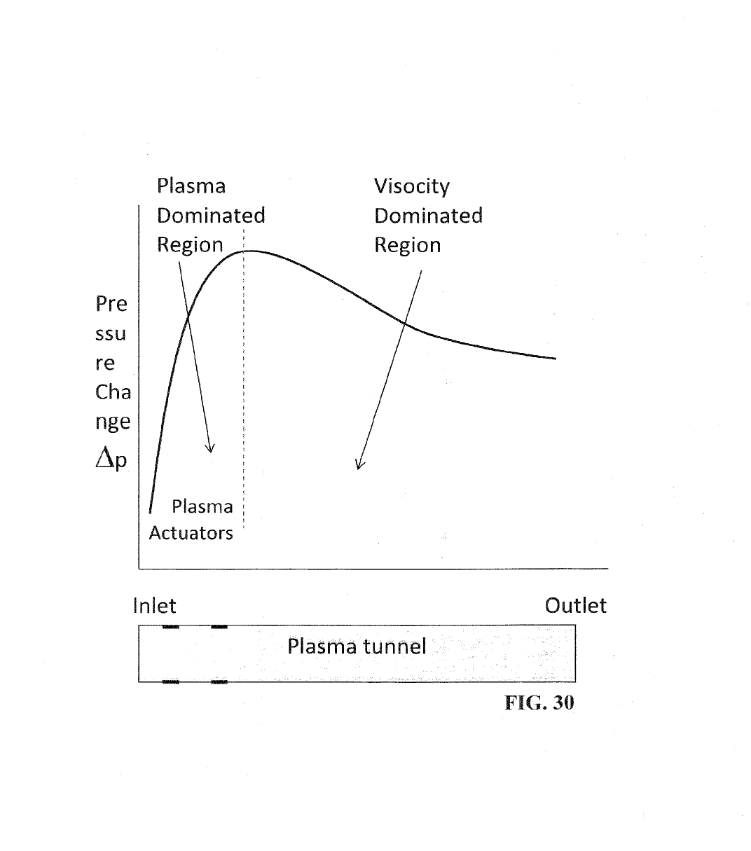

The wind tunnel can include a flow generation portion including the electrode pair or pairs and a test portion where the test subject is positioned. A pressure within the wind tunnel can decrease from the flow generation portion to the test portion. That is, the electrohydrodynamic body force can generate a pressure change within the wind tunnel. FIG. 30 shows the pressure change as a function of position in a wind tunnel without a screen, in accordance with an embodiment of the invention. Referring to FIG. 30, the pressure change generated in the flow generation portion can be seen. The pressure change can be any range or value within the endpoints of 0.01 Pa/m to 100 Pa/m. For example, the pressure change can be in the range of 10 Pa/m to 25 Pa/m.

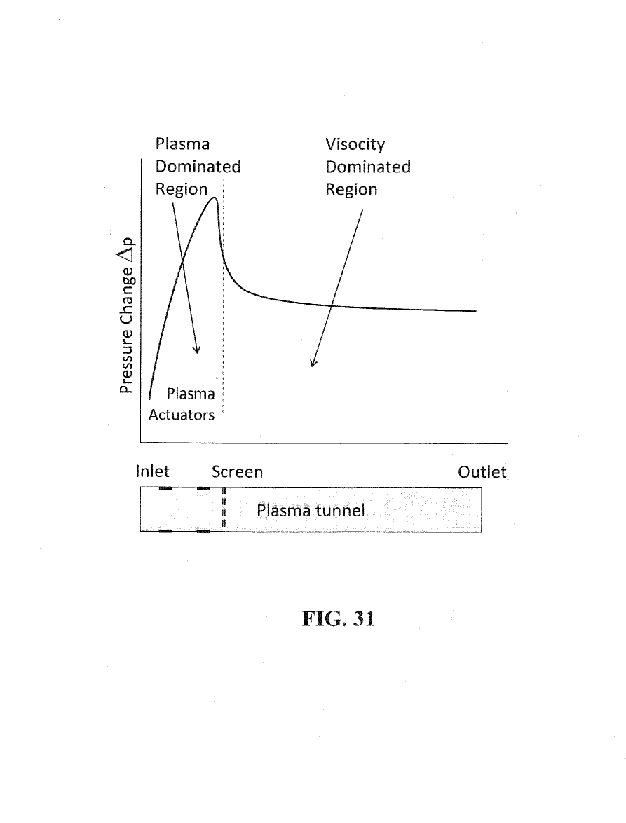

In an embodiment, the wind tunnel can also include a screen between the flow generation portion and the test portion. The screen can reduce large scale flow structures in the flow, if any, generated in the flow generation portion. FIG. 31 shows the pressure change as a function of position in a wind tunnel including a screen, in accordance with an embodiment of the invention.

In certain embodiments, the pressure variation generated by the electrohydrodynamic body force can increase as the applied voltage potential increases. In an embodiment, the pressure change generated by the electrohydrodynamic body force can increase exponentially as the applied voltage potential increases. For example, the pressure change generated by the electrohydrodynamic body force can be proportional to Vⁿ, where V is the applied voltage potential and n is at least 3. In a further embodiment, n can be at least 4.

In certain embodiments, the pressure change generated in the wind tunnel increases as the number of electrode pairs increases. In an embodiment, the pressure change generated in the wind tunnel can increase approximately linearly as the frequency of the applied voltage increases. The geometry of the electrode pairs can also affect the pressure change.

In an embodiment, the fluid in the wind tunnel can be a liquid. In an alternative embodiment, the fluid in the wind tunnel can be a gas or gas mixture. For example, the fluid in the wind tunnel can be air.

In an embodiment, the induced fluid flow can be continuum flow, laminar flow, or transitional flow.

In an embodiment, at least one electrode of the pair of electrodes can be exposed to the fluid within the flow passage. In a further embodiment, one of the electrodes of the pair of electrodes can be embedded in an insulating material, such that it is electrically separated from the exposed electrode and is not exposed to the fluid within the flow passage.

In an embodiment, a wind tunnel can include: a flow passage having at least one surface; at least one pair of electrodes; and a power supply configured to apply a voltage potential across one or more of the at least one pair of electrodes to produce a plasma discharge in the flow passage when a fluid is in the flow passage. Each electrode of the pair of electrodes can be positioned on or proximate the at least one surface of the flow passage such that, when the plasma discharge is produced, an electrohydrodynamic body force is generated that induces a fluid flow within the flow passage. The wind tunnel can optionally include one or more additional electrode pairs, and a voltage potential can be applied across one or more of the additional electrode pairs.

In an embodiment, the wind tunnel surface or surfaces can include an insulating material. At least one electrode of the pair of electrodes can be exposed to the fluid within the flow passage. In a further embodiment, one of the electrodes of the pair of electrodes can be embedded in an insulating material, such that it is electrically separated from the exposed electrode and is not exposed to the fluid within the flow passage.

At least one characteristic of the test subject in the path of the fluid flow can be determined using the methods and wind tunnels of the subject invention. For example, one of the following characteristics can be determined: drag coefficient, lift coefficient, aerodynamic force, speed of fluid flow around the test subject, and/or direction of fluid flow around the test subject.

Advantageously, in the methods and wind tunnels according to embodiments of the subject invention, applying the voltage potential across the pair of electrodes generates minimal to no mechanical vibration on the surface(s) of the wind tunnel.

Advantageously, the wind tunnels according to embodiments of the subject invention can be operated using much less power than conventional wind tunnels, which often require hundreds of Watts of power. Wind tunnels according to embodiments of the subject invention can be operated using, for example, power in a range having any of the following endpoints (or can be operated at any of the following values): 1 W, 5 W, 10 W, 20 W, 30 W, 40 W, 50 W, 60 W, 70 W, 80 W, 90 W, or 100 W. For example, in an embodiment, a wind tunnel can be operated using power in a range of 1 W to 100 W. In a further embodiment, a wind tunnel can be operated using power in a range of 10 W to 100 W. In a further embodiment, a wind tunnel can be operated using power in a range of 10 W to 50 W. In a further embodiment, a wind tunnel can be operated using power in a range of 50 W to 100 W. In a further embodiment, a wind tunnel can be operated using power in a range of 20 W to 80 W. In a further embodiment, a wind tunnel can be operated using power in a range of 10 W to 70 W. In a further embodiment, a wind tunnel can be operated using power in a range of 10 W to 30 W. In a further embodiment, a wind tunnel can be operated using power in a range of 10 W to 20 W.

Aspects of the invention can be described in the general context of computer-executable instructions, such as program modules, being executed by a computer. Generally, program modules include routines, programs, objects, components, data structures, etc., that perform particular tasks or implement particular abstract data types. Such program modules can be implemented with hardware components, software components, or a combination thereof. Moreover, those skilled in the art will appreciate that the invention can be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, formats, and numerous other details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention can be practiced without these specific details. Computer systems, servers, work stations, and other machines can be connected to one another across a communication medium including, for example, a network or networks.

As one skilled in the art will appreciate, embodiments of the present invention can be embodied as, among other things: a method, system, or computer-program product. Accordingly, the embodiments can take the form of a hardware embodiment, a software embodiment, or an embodiment combining software and hardware. In an embodiment, the present invention takes the form of a computer-program product that includes computer-useable instructions embodied on one or more computer-readable media. Methods, data structures, interfaces, and other aspects of the invention described above can be embodied in such a computer-program product.

Computer-readable media include both volatile and nonvolatile media, removable and nonremovable media, and contemplate media readable by a database, a switch, and various other network devices. By way of example, and not limitation, computer-readable media include media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. In an embodiment, non-transitory media are used.

The invention can be practiced in distributed-computing environments where tasks are performed by remote-processing devices that are linked through a communications network or other communication medium. In a distributed-computing environment, program modules can be located in both local and remote computer-storage media including memory storage devices. The computer-useable instructions form an interface to allow a computer to react according to a source of input. The instructions cooperate with other code segments or modules to initiate a variety of tasks in response to data received in conjunction with the source of the received data.

The present invention can be practiced in a network environment such as a communications network. Such networks are widely used to connect various types of network elements, such as routers, servers, gateways, and so forth. Further, the invention can be practiced in a multi-network environment having various, connected public and/or private networks.

Communication between network elements can be wireless or wireline (wired). As will be appreciated by those skilled in the art, communication networks can take several different forms and can use several different communication protocols.

Embodiments of the subject invention can be embodied in a processing system. Components of the processing system can be housed on a single computer or distributed across a network as is known in the art. In an embodiment, components of the processing system are distributed on computer-readable media. In an embodiment, a user can access the processing system via a client device. In an embodiment, some of the functions or the processing system can be stored and/or executed on such a device. Such devices can take any of a variety of forms. By way of example, a client device may be a desktop, laptop, or tablet computer, a personal digital assistant (PDA), an MP3 player, a communication device such as a telephone, pager, email reader, or text messaging device, or any combination of these or other devices. In an embodiment, a client device can connect to the processing system via a network. As discussed above, the client device may communicate with the network using various access technologies, both wireless and wireline. Moreover, the client device may include one or more input and output interfaces that support user access to the processing system. Such user interfaces can further include various input and output devices which facilitate entry of information by the user or presentation of information to the user. Such input and output devices can include, but are not limited to, a mouse, touch-pad, touch-screen, or other pointing device, a keyboard, a camera, a monitor, a microphone, a speaker, a printer, a scanner, among other such devices. As further discussed above, the client devices can support various styles and types of client applications.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A method of applying a fluid flow to a test subject, comprising:
providing a wind tunnel comprising a flow passage having at least one surface;
providing a pair of electrodes, wherein each electrode of the pair of electrodes is positioned on or proximate one or more of the at least one surface;
introducing a fluid into the flow passage;
applying a voltage potential across the pair of electrodes to produce a plasma discharge in the flow passage, such that when the plasma discharge is produced an electrohydrodynamic body force is generated that induces a fluid flow within the flow passage; and
positioning the test subject in a path of the fluid flow.

2. The method according to claim 1, wherein the fluid within the flow passage flows at a speed of no more than 15 meters per second.

3. The method according to claim 1, wherein the fluid within the flow passage flows at a speed of no more than 10 meters per second.

4. The method according to claim 1, wherein the electrohydrodynamic body force generates a pressure change within the wind tunnel in the range of 10 Pa/m to 25 Pa/m.

5. The method according to claim 1, wherein the pair of electrodes are configured such that a pressure change generated by the electrohydrodynamic body force increases exponentially as the applied voltage potential increases.

6. The method according to claim 5, wherein the pressure change generated by the electrohydrodynamic body force is proportional to Vⁿ, wherein V is the applied voltage potential and n is at least 3.

7. The method according to claim 1, further comprising determining at least one characteristic of the test subject in the path of the fluid flow, wherein the at least one characteristic is selected from the group consisting of: drag coefficient, lift coefficient, aerodynamic force, speed of fluid flow around the test subject, and direction of fluid flow around the test subject.

8. The method according to claim 1, wherein the fluid is a gas or gas mixture.

9. The method according to claim 1, wherein the fluid is air.

10. The method according to claim 1, wherein the fluid is a liquid.

11. The method according to claim 1, wherein the induced fluid flow is continuum flow, laminar flow, or transitional flow.

12. The method according to claim 1,
wherein the at least one surface comprises an insulating material,
wherein the pair of electrodes comprises an exposed electrode and an embedded electrode,
wherein the exposed electrode is exposed to the fluid within the flow passage,
wherein the embedded electrode is separated from the exposed electrode by the insulating material, and
wherein the embedded electrode is not exposed to the fluid within the flow passage.

13. The method according to claim 1, wherein applying the voltage potential across the pair of electrodes generates no mechanical vibration on the at least one surface of the wind tunnel.

14. The method according to claim 1,
wherein the wind tunnel comprises at least one additional pair of electrodes;
wherein each electrode of the at least one additional pair of electrodes is positioned on or proximate one or more of the at least one surface of the flow passage; and
wherein the method further comprises applying an additional voltage potential across the at least one additional pair of electrodes.

15. The method according to claim 1, wherein each electrode of the pair of electrodes has a plurality of turns formed therein.

16. The method according to claim 1, wherein each electrode of the pair of electrodes has a serpentine shape comprising at least two periods.

17. The method according to claim 15,
wherein the pair of electrodes comprises a first electrode and a second electrode;
wherein the plurality of turns formed in the first electrode correspond to the plurality of turns formed in the second electrode; and
wherein each of the plurality of turns formed in the first electrode is positioned on the first electrode in the same order as the corresponding turn in the second electrode.

18. The method according to claim 1, wherein the wind tunnel comprises a flow generation portion and a test portion, wherein the pair of electrodes are positioned in the flow generation portion, wherein the test subject is positioned in the test portion, wherein a pressure within the wind tunnel decreases from the flow generation portion to the test portion.

19. The method according to claim 18, wherein the wind tunnel further comprises a screen between the flow generation portion and the test portion.

20. A wind tunnel, comprising:
a flow passage having at least one surface;
a pair of electrodes; and
a power supply configured to apply a voltage potential across the pair of electrodes to produce a plasma discharge in the flow passage when a fluid is in the flow passage,
wherein each electrode of the pair of electrodes is positioned on or proximate the at least one surface of the flow passage such that when the plasma discharge is produced an electrohydrodynamic body force is generated that induces a fluid flow within the flow passage.

21. The wind tunnel according to claim 20,
wherein the one of the at least one surface comprises an insulating material;
wherein the pair of electrodes comprises an exposed electrode and an embedded electrode;
wherein the exposed electrode is exposed to an interior of the flow passage; and
wherein the embedded electrode is separated from the exposed electrode by the insulating material and is not exposed to the interior of the flow passage.

22. The wind tunnel according to claim 20, wherein the wind tunnel is configured such that fluid within the flow passage flows at a speed of no more than 15 meters per second.

23. The wind tunnel according to claim 20, wherein the wind tunnel is configured such that fluid within the flow passage flows at a speed of no more than 10 meters per second.

24. The wind tunnel according to claim 20, wherein the electrohydrodynamic body force generates a pressure change within the wind tunnel in the range from 10 Palm to 25 Pa/m.

25. The wind tunnel according to claim 20, wherein the pair of electrodes are configured such that a pressure change generated by the electrohydrodynamic body force increases exponentially as the applied voltage potential increases.

26. The wind tunnel according to claim 25, wherein the pressure change generated by the electrohydrodynamic body force is proportional to Vⁿ, wherein V is the applied voltage potential and n is at least 3.

27. The wind tunnel according to claim 20, wherein the wind tunnel is configured such that the induced fluid flow is continuum flow, laminar flow, or transitional flow.

28. The wind tunnel according to claim 20, wherein the wind tunnel is configured such that the applying the voltage potential across the pair of electrodes generates no mechanical vibration on the at least one surface of the wind tunnel.

29. The wind tunnel according to claim 20, further comprising at least one additional pair of electrodes, wherein each electrode of the at least one additional pair of electrodes is positioned on or proximate the one or more of the at least one surface of the flow passage.

30. The wind tunnel according to claim 20, wherein each electrode of the pair of electrodes has a plurality of turns formed therein.

31. The wind tunnel according to claim 20, wherein each electrode of the pair of electrodes has a serpentine shape comprising at least two periods.

32. The wind tunnel according to claim 20,
wherein the pair of electrodes comprises a first electrode and a second electrode;
wherein the plurality of turns formed in the first electrode correspond to the plurality of turns formed in the second electrode; and
wherein each of the plurality of turns formed in the first electrode is positioned on the first electrode in the same order as the corresponding turn in the second electrode.

33. The wind tunnel according to claim 20, wherein the wind tunnel comprises a flow generation portion and a test portion, wherein the pair of electrodes are positioned in the flow generation portion, wherein the test subject is positioned in the test portion, wherein a pressure within the wind tunnel decreases from the flow generation portion to the test portion.

34. The wind tunnel according to claim 33, wherein the wind tunnel further comprises a screen between the flow generation portion and the test portion.
